(19) United States
(12) Patent Application Publication
(10) Pub. No.: US 2026/0351431 A1
(43) Pub. Date: Nov. 5, 2026

(54) CONVERGING-FRONT LASER ION ACCELERATION

(71) Applicant: CONRNELL UNIVERSITY, Ithaca, NY (US)

(72) Inventors: Jihoon KIM, Ithaca, NY (US); Roopendra Singh RAJAWAT, Ithaca, NY (US); Tianhong WANG, Sunnyvale, CA (US); Gennady SHVETS, Ithaca, NY (US)

(21) Appl. No.: 19/119,318

(22) PCT Filed: Oct. 10, 2023
(86) PCT No.: PCT/US2023/034823

§ 371 Date: Apr. 8, 2025

Related U.S. Application Data
(60) Provisional application No. 63/415,045, filed on Oct. 11, 2022.

(51) Int. Cl. G21B 1/19; G21B 1/03; G21B 1/23; H05H 6/00; H05H 15/00

(52) U.S. Cl. CPC G21B 1/19; G21B 1/23; H05H 15/00; G21B 1/03; H05H 6/00

(57) ABSTRACT

A method for laser-based ion acceleration includes illuminating a convex front face of a solid target with a laser pulse. This illuminating generates an ion beam and accelerates the ion beam based at least in part on hole-boring radiation pressure acceleration (HB-RPA) such that the ion beam is focused onto a focal point located behind a rear face of the target. To ensure that the ions are accelerated via the HB-RPA, the solid target may have a thickness, as measured between the rear face and a transverse center of the convex front face, of 1 μm or more.

### RELATED APPLICATIONS

This application claims priority to U.S. Provisional Patent Application No. 63/415,045, filed on Oct. 11, 2022 and titled “Converging Surface Ion Acceleration,” which is incorporated herein by reference in its entirety.

### STATEMENT REGARDING FEDERALLY SPONSORED RESEARCH OR DEVELOPMENT

This invention was made with government support under grant number PHY-2109087 awarded by the National Science Foundation. The government has certain rights in the invention.

### BACKGROUND

Chirped pulse amplification (CPA) [1] has enabled investigation of ultra-intense light-matter interactions, in turn driving the development of multi-petawatt lasers [2]. One application for such lasers is ion acceleration [3-8]. Here, the laser imparts energy to dense electrons, separating them from bulk ions at the front surface [5-9] or rear surface [10-13] of an illuminated target. The resulting charge-separation force accelerates the ions to energies up to tens of mega-electron-volts (MeV), or more, within distances as short as a few microns, thus giving this setup its nickname “table-top ion accelerator.” These high-intensity laser pulses are ultrashort (e.g., femtosecond to picosecond) and often tightly focused (e.g., tens of microns), which in turn generates ion beams with comparable dimensions.

### SUMMARY

Many applications of ion beams require energy fluxes that are higher than what can be achieved with current technologies. For example, fast ignition (FI) [14-17] of targets using inertial confinement fusion (ICF) [18-20] requires the delivery of energy fluxes on the order of GJ/cm² to heat the compressed fusion fuel and achieve a net energy gain [6, 21]. While there have been proposals to generate such ion beams via extremely energetic and powerful (e.g., 45 kJ, 60 PW) lasers [6], such lasers are still unavailable [2].

One way to achieve higher energy flux without increasing laser energy and power is by focusing the ions. Several methods have been proposed, including the combination of a rear-shaped target (i.e., a target whose rear face is not planar) and target normal sheath acceleration (TNSA) with or without a guiding cone [11, 22], post-acceleration focusing of ion beams using a cylindrical expanding sheath [23], and an ultrathin parabolic target that self-folds onto itself at a single focal point [24, 25]. Many of these schemes require additional manipulation for the ion beams to meet the needs of the application at hand. For example, TNSA generates hot electrons which leads to ions with exponential energy spectra [10]. Furthermore, it primarily accelerates lighter ions (e.g., protons) and often has low energy conversion from laser to ions. In another example, post-acceleration focusing requires a separate laser and enough space to implement the focusing mechanism. While the self-folding target yields a monoenergetic, well-focused ion beam, this technique also generates highly relativistic ions, thus limiting its applicability.

The present embodiments include systems, devices, and methods that implement a technique that generates and accelerates ions into beams with monoenergetic spectra and arbitrary mean energy. The technique also focuses these ion beams down to a predefined focal length. This technique, referred to herein as converging-front laser ion acceleration (CLIA), combines hole-boring radiation pressure acceleration (HIB-RPA) with a target whose front face is convex. This convex front face is similar to the curved face of an optical lens used to focus light. Similarly, the target used for CLIA focuses ions onto a focal point that is located behind the rear face of the target by approximately the focal length.

CLIA is based on two key mechanisms. First, a planar laser beam interacting with a thick overdense plasma target maintains the shape of the plasma-laser interface (PLI) throughout the entire HB-RPA process. Second, the convex front face of the target imparts ions with transverse velocities that are directed towards the optical axis. The magnitude of the transverse velocity increases with the transverse distance from the optical axis. Due to these two effects, CLIA can advantageously generate monoenergetic ion beams with energy fluxes up to an order of magnitude, or more, higher than what can be achieved with conventional flat targets. Another advantage of CLIA is that the peak beam energy and focal length can be independently controlled, the former by tuning the target and laser parameters and the latter by modifying the shape of the convex front surface.

### BRIEF DESCRIPTION OF THE FIGURES

FIGS. 1A, 1B, and 1C are side views illustrating converging-front laser ion acceleration (CLIA), a laser-based technique for generating, accelerating, and focusing an ion beam, in accordance with the present embodiments.

FIGS. 2A-2D are side views of additional targets that may be used for CLIA, in some embodiments.

FIG. 3 is a side view illustrating CLIA with a double target, in an embodiment.

FIG. 4 is a side view illustrating CLIA with several targets arranged with spatially overlapping focal points, in an embodiment.

FIG. 5 shows the results of a three-dimensional (3D) particle-in-cell (PIC) simulation (Simulation I).

FIG. 6 illustrates the theoretical description of CLIA.

FIG. 7 illustrates field structure and ion beam propagation for CLIA.

FIG. 8 illustrates the dependence of CLIA on laser-plasma parameters.

FIG. 9 is a comparison of target front shape and laser transverse profile.

FIG. 10 illustrates multispecies CLIA simulation results for a CH₁₂ target.

FIG. 11 shows (a) a contour plot of on-target powers Pₜ as a function of laser field strength a₀ and focal length R_{c} and (b) a plot of energy spectra of accelerated ions.

### DETAILED DESCRIPTION

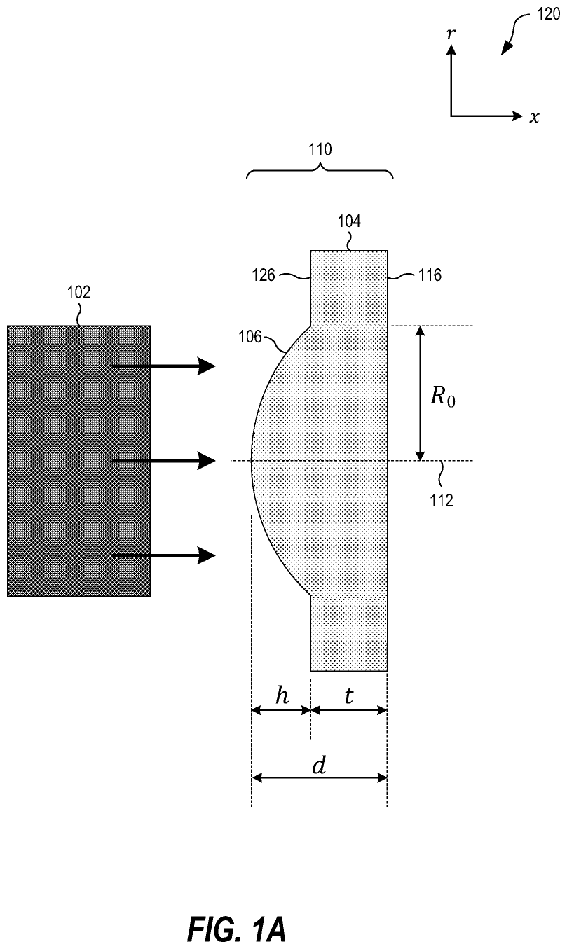

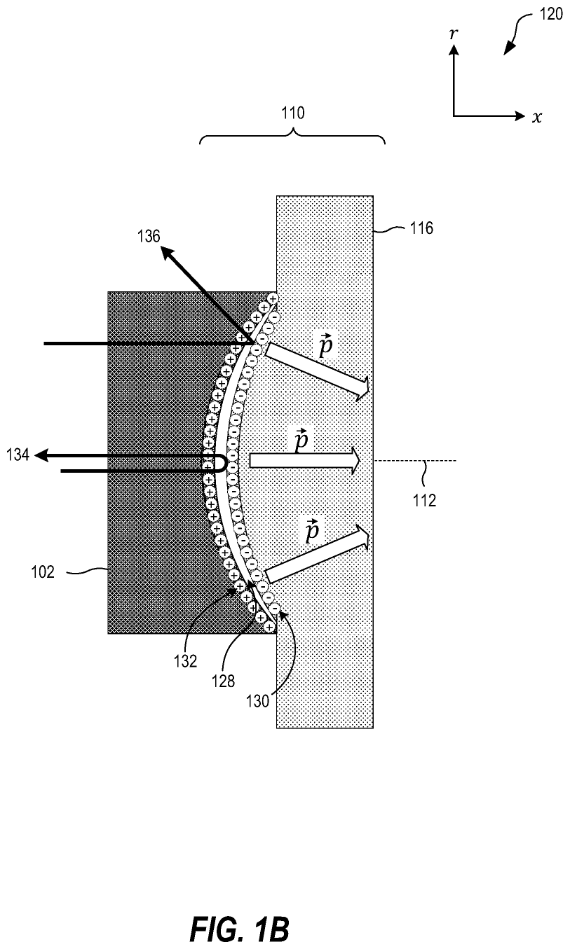

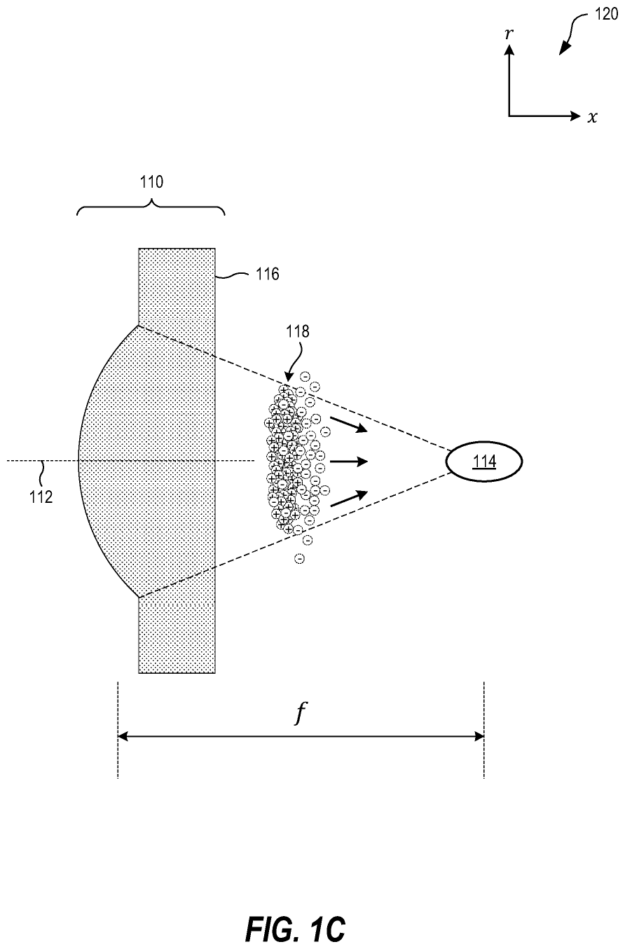

FIGS. 1A, 1B, and 1C are side views illustrating converging-front laser ion acceleration (CLIA), a laser-based technique for generating, accelerating, and focusing an ion beam 118, in accordance with the present embodiments. FIGS. 1A, 1B, and 1C are best viewed together with the following description. In the example of CLIA shown in FIGS. 1A, 1B, and 1C, a laser pulse 102 propagating in the +x direction (see coordinate system 120) illuminates a convex front face 106 of a solid target 110. As shown in FIG. 1C, the ion beam 118 is emitted from a rear face 116 of the target 110 and is focused onto a focal point 114. The ion beam 118 may include any one or more types of positively charged ions. Examples include, but are not limited to, oxygen ions, carbon ions, lithium ions, aluminum ions, deuterium ions, α particles, and protons. While the ions may all have the same charge or a combination of different charges, it is assumed herein for simplicity that the ions are singly charged (i.e., +e).

In FIG. 1A, the convex front face 106 protrudes axially outward (i.e., in the −x direction), from a front planar surface 126 of a substrate 104 of the target 110, by a protrusion distance h. A peak of the convex front face 106 is axially separated from the planar rear face 116 by a target thickness d. Thus, the substrate 104 has a substrate thickness t=d−h. The convex front face 106 may have cylindrical symmetry about the optical axis 112. In this case, the boundary between the convex front face 106 and the front planar surface 126 forms a circle having a radius R₀ and centered on the optical axis 112. In some embodiments, the radius R₀ is 1 μm or more. The convex front face 106 may alternatively have a different type of symmetry. For example, the convex front face 106 may have discrete rotational symmetry about the optical axis 112, mirror symmetry about a reflection plane that coincides with the optical axis 112, or no symmetry at all with respect to the optical axis 112.

FIG. 1B illustrates the first stages of CLIA, which is also referred to as the “acceleration” stage. Here, ions are accelerated from an overdense plasma via hole-boring radiation pressure acceleration (HB-RPA). The parameters of the laser pulse 102 and target 110 are selected such that the ions are accelerated primarily via HB-RPA, as opposed to other laser-based ion-acceleration mechanisms (e.g., light-sail radiation pressure acceleration (LS-RPA), target normal sheath acceleration (TNSA), break-out afterburner (BOA), etc.). Specifically, the target thickness d may be greater than or equal to a center wavelength A, of the laser pulse 102 This constraint ensures that most, if not all, of the energy of the laser pulse 102 has been expended before the laser pulse 102 can reach the rear face 116. In this case, little, if any, portion of the laser pulse 102 exits the rear face 116 and interacts with the ion beam 118, via LS-RPA, in the region of free space behind (i.e., in the +x direction) the target 110. In some embodiments, the target thickness d is 1 μm or more.

In practice, it is difficult to ensure that HB-RPA is the only ion-acceleration mechanism that occurs when the laser pulse 102 interacts with the target 110. The advantages of the present embodiments can be attained as long as some of the ions are accelerated and focused with HB-RPA. Accordingly, parameters of one or both of the laser pulse 102 and target 110 may be selected such that the ions are accelerated based at least in part on HB-RPA. In some embodiments, HB-RPA is the primary, but not necessarily the only, ion-acceleration mechanism. In other embodiments, HB-RPA dominates over all other ion-acceleration mechanisms, in which case it may be possible to completely ignore these other mechanisms.

The leading edge of the laser pulse 102 ionizes the atoms forming the front face 106, releasing a cloud of free electrons. Since these free electrons were responsible for binding the atoms together into the solid-state material forming the target 110, this ionization creates a quasi-neutral plasma. The cloud of free electrons is initially superimposed over a cloud of free ions that are released from the target 110. For clarity in FIG. 1B, free ions are represented by the plus sign + while free electrons are represented by the minus sign −.

The interaction between the free electrons and the laser pulse 102 give rise to ponderomotive pushing and pulling forces that preferentially push the free electrons forward in the +x direction. This preferentially pushing, also known as “radiation pressure” and denoted \vec{p} in FIG. 1B, is also applied to the free ions, albeit in the opposite direction due to their positive charges. However, due to the much greater mass of the ions, as compared to the electrons, the resulting acceleration of the free ions, as caused by the radiation pressure, is negligible.

FIG. 1B illustrates laser-induced spatial separation of the free ions and free electrons into a double-layer structure in which an electron layer 130 and an ion layer 132 are separated by a charge-separation layer 128. Due to the radiation pressure \vec{p}, the laser pulse 102 can be thought of as a “piston” or “snowplow” that pushes the free electrons forward, thereby increasing their density and spatially separating them from the free ions. The density of the free electrons increases to the point that the resulting electron layer 130 is overcritical or overdense (i.e., it has a density exceeding the critical density) and therefore cannot support propagation of the laser pulse 102 therethrough. Instead, the laser pulse 102 primarily reflects off the electron layer 130 at the plasma-laser interface (PLI), i.e., the front surface of the electron layer 130 where the electron density rapidly transitions between a value far below the critical density (in the charge-separation layer 128) and a value far above the critical density (inside the electron layer 130). A very small portion of the laser pulse 102 penetrates the electron layer 130, where it is rapidly attenuated via the skin effect. The reflection of the laser pulse 102 off the electron layer 130 (and the small amount of absorption due to the skin effect) transfers momentum from the laser pulse 102 to the electron layer 130 via the same radiation pressure \vec{p} described above, thereby accelerating the electron layer 130 primarily in the forward direction.

The spatial separation shows in FIG. 1B gives rise to a strong shock-like electrostatic force between the electron layer 130 and the ion layer 132. The forward motion of the electron layer 130 drags the ion layer 132 behind it, thereby accelerating the ions forward. The ions increase in density to form the ion layer 132. However, due to the much heavier mass of the ions, the ion layer 132 remains below its critical density. Accordingly, the laser pulse 102 can propagate through the ion layer 132 to reach, and reflect off of, the electron layer 130.

The electrostatic force between the ion layer 132 and the electron layer 130 not only accelerates the ion layer in the +x direction, but it also accelerates the electron layer 130 in the −x direction. The electron layer 130 should gain sufficient forward momentum from the laser pulse 102 to ensure that it always remains moving in the forward direction. If this condition is not, the electron layer 130 will reverse directions and move towards the ion layer 132, thereby destroying the double-layer structure. Laser intensities in the relativistic regime (e.g., 10¹⁸ W/cm² or more) are generally sufficient to meet this condition. In some embodiments, the laser pulse 102 has a peak intensity of 10²⁰ W/cm² or more. In some of these embodiments, the laser pulse 102 has a peak intensity of 10²² W/cm² or more.

Due to the convex shape of the front face 106, the resulting overdense electron layer 130 also has a convex face that acts like a convex mirror surface off of which the laser pulse 102 reflects. It is assumed in FIGS. 1A and 1B that the laser pulse 102 is a plane wave, i.e., the laser pulse 102 has a k-vector that everywhere points in the +x direction. The portion of the laser pulse 102 propagating coaxially with the optical axis 112 reflects normally (i.e., at a zero-degree angle of incidence) off the electron layer 130. As shown in FIG. 1B, a resulting normal reflection 134 propagates in the −x direction, with the resulting radiation pressure p being oriented only in the +x direction. However, portions of the laser pulse 102 that are transversely displaced from the optical axis 112 do not reflect normally. Instead, these portions of the laser pulse 102 are reflected away from the optical axis 112. As shown in FIG. 1B, a resulting non-normal reflection 136 produces radiation pressure \vec{p} with a transverse component that pushes the electron layer 130 toward the optical axis 112. The magnitude of this transverse component increases with transverse position, i.e., the farther from the optical axis 112 the electrons are located, the greater the transverse momentum they receive.

While the double-layer structure moves forward through the remaining unused portion of the target 110 to reach the rear face 116, the transverse momentum pushes the outer regions of the electron layer 130 transversely inwards, thereby spatially compressing the electron layer 130. The PLI remains convex during this process and its convex shape is transferred to the ion layer 132 via the electrostatic interaction. Accordingly, the electron layer 130 and ion layer 132 maintain a convex double-layer structure while moving.

The unused portion of the target 110 between the electron layer 130 and the rear face 116 may be solid state material, ionized (e.g., plasma), or both. When the target 110 is relatively thin (e.g., the target thickness d is less than ~100 μm), the laser pulse 102 may be so intense that the exponentially decaying evanescent field it induces can ionize some of the unused portion before the double-layer structure passes therethrough. In this case, ions in the unused portion remain unaccelerated until the forward-moving double-layer structure arrives. When the intensity of the laser pulse 102 is relative lower or when the target 110 is relatively thick (e.g., the target thickness d is greater than ~100 μm), then some of the unused portion may remain in its initial solid state until the double-layer structure arrives.

FIG. 1C shows the second stage of CLIA, which is also referred to as the “coasting” stage. Here, the electron layer 130 and ion layer 132 exit the target 110 via the rear face 116 and move through the free-space region behind the target 110. In this free-space region, the ion layer 132 forms the ion beam 118. In the coasting stage, it is assumed that none of the laser pulse 102 propagates through the target 110, and therefore the electrons and ion beam 118 do not interact with the laser pulse 102. However, transverse compression of the ions continues due to the transverse velocities of the ions.

As the ion beam 118 moves forward, it is maximally compressed (i.e., has its greatest density) at the focal point 114, which is located a focal length f behind the target 110. Due to thermal pressure, the cloud of electrons rapidly expands and may not reach maximal compression before reaching the focal point 114. For this reason, FIG. 1C shows the electrons as more spatially dispersed than the ion beam 118, in both the longitudinal and transverse directions, and partially overlapped with the ion beam 118.

Similarly to optical lens design, the focal length f may be determined, at least in part, by the shape (e.g., curvature) of the front face 106. The energy of the ion beam 118 may be deposited into a sample located at or near the focal point 114. For example, the ion beam 118 may be used to trigger nuclear fusion by igniting a pellet (e.g., deuterium-tritium, deuterium-deuterium, boron, etc.) placed at the focal point 114. Alternatively, the ion beam 118 may be used to deliver energy into a sample of biological tissue placed at the focal point 114 (e.g., proton therapy).

In some embodiments, the target 110 is paraboloidal, i.e., the front face 106 is shaped as a paraboloid. In this case, and as described in more detail below, the PLI is also shaped as a paraboloid. Furthermore, the double-layer structure maintains this paraboloidal shape of the PLI throughout the acceleration stage. Similar to parabolic optical lenses and reflectors, the paraboloidal target 110 can focus the ion beam 118 with minimal, if any, spherical aberration. Accordingly, it is expected that for a monoenergetic ion beam 118, the paraboloidal target 110 can achieve higher compressions than certain other types of surface profiles.

In some embodiments, the front face 106 has a shape that approximates a paraboloid. For example, the shape may be spherical, which approximates a paraboloid near the optical axis 112. In other embodiments, the front face 106 is only convex in one of the two linear transverse dimensions. In these embodiments, the target 110 is akin to a cylindrical lens that only focuses in one dimension. In other embodiments, the front face 106 is aspherical, akin to an aspheric lens in optics. In some of these embodiments, the front face 106 has a shape that is parabolic to at least first order with respect to transverse distance from the optical axis 112. The front face 106 may alternatively have a different shape (e.g., hyperboloid, ellipsoid, etc.) or combination of shapes without departing from the scope hereof.

In the example shown in FIGS. 1A, 1B, and 1C, the rear face 116 of the target 110 is planar. However, the rear face 116 may alternatively have a different shape (e.g., curved). In some embodiments, target 110 is made from an aerogel, an aerographite, a carbon nanofoam, or a combination thereof. The solid material from which the target 110 is formed may have a mass density of 0.2 g/cm³ or less. In some embodiments, the target 110 is filled in that in lacks internal macroscopic gaps, bubbles, or cavities.

To obtain the intensities necessary for CLIA, the laser pulse 102 may be produced by amplifying a low-power seed pulse. The seed pulse may be generated, for example, with a titanium:sapphire (Ti:Saph) femtosecond laser, in which case λ_{c}≈800 nm. The output of the Ti:Saph laser may be frequency doubled such that λ_{c}≈400 nm. Alternatively, the seed pulse may be generated with a fiber-based femtosecond laser (e.g., ytterbium-doped fiber) or glass-based laser (e.g., Nd:glass), in which case λ_{c}≈1050 nm. Another type of laser source or nonlinear frequency-generation technique may be used to generate the seed pulse and therefore the center wavelength λ_{c} not limited to example values presented above. Amplification may be implemented with multiple stages (e.g., preamplifier stages, main amplifier stages, etc.). In some embodiments, the seed pulse is amplified via chirped pulse amplification (CPA).

In some embodiments, the laser pulse 102 is a femtosecond pulse, having a duration between 1 and 1000 fs. In some of these embodiments, the laser pulse 102 has a duration between 10 and 200 fs. In other embodiments, the laser pulse is a picosecond pulse having a duration of 1 ps or more. In some embodiments, the laser pulse 102 is circularly polarized or elliptically polarized. Alternatively, the laser pulse 102 may be linearly polarized.

In some embodiments, the laser pulse 102 has a Gaussian profile, and is therefore not a true plane wave. To achieve the highest intensities, the laser pulse 102 may be focused onto the target 110 such that its beam waist occurs at the front face 106. In this case, the laser pulse 102 has essentially no wavefront curvature as it interacts with the front face 106. Equivalently, the k-vector of the laser pulse 102, at the beam waist, points in the +x direction everywhere across the Gaussian profile. The Gaussian transverse profile may be circular or elliptical. In some embodiments, the laser pulse 102 has a super-Gaussian profile. As compared to a Gaussian profile, and described in more detail below, a super-Gaussian profile has more energy distributed away from the profile center, and therefore better approximates a plane wave. In other embodiments, the laser pulse 102 has a top-hat or flat-top profile. The laser pulse 102 may have a different type of transverse profile without departing from the scope hereof.

In some embodiments, the laser pulse 102 has a spot size, or beam diameter, at the front face 106 of at least 4 μm. For a Gaussian profile, the spot size may be defined as twice the beam waist, where the beam waist is the transverse distance from the optical axis 112 where the intensity of the laser pulse 102 has dropped to 1/e² of its value at the optical axis 112. The beam waist may be equal to the minimum beam waist, which occurs when the laser pulse 102 is focused onto the front face 106. A different definition of spot size or beam diameter may be used, particularly for when the laser pulse 102 has a non-Gaussian profile.

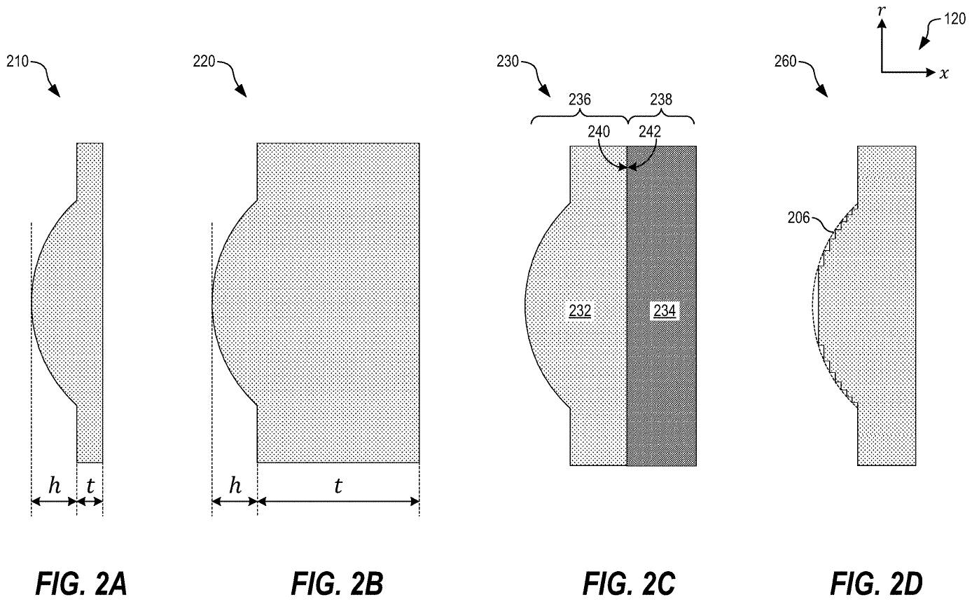

FIGS. 2A-2D are side views of additional targets that may be used for CLIA. Specifically, FIG. 2A shows a target 210 that is similar to the target 110 of FIG. 1A except that the protrusion distance h is greater than the substrate thickness t. FIG. 2B shows a target 220 that is similar to the target 210 of FIG. 2A except that the protrusion distance h is less than the substrate thickness t. Therefore, the protrusion distance h may, in general, be greater than, less than, or equal to the substrate thickness t. In other embodiments, the target 110 excludes the substrate 104, in which case the protrusion distance h equals the target thickness d.

FIG. 2C shows a target 230 that has a front portion 236 made from a first solid-state material 232 and a rear portion 238 made from a second solid-state material 234 that is different from the first solid-state material 232. The solid-state materials 234 and 236 may have different properties, such as mass density. The front portion 236 is shaped similarly to the target 110 of FIG. 1A, having a first intermediate face 240 that is planar. The rear portion 238 has a second intermediate face 242 that is planar and directly contacts the first intermediate face 240. The thickness (along x) of the rear portion 238 may be greater than, less than, or equal to the thickness of the front portion 236. More generally, the target 230 may be made from two or more different solid-state materials. While FIG. 2C shows the target 230 with the solid-state materials 232 and 234 forming layers, the two or more solid-state materials may be shaped differently without departing from the scope hereof.

FIG. 2D is a side view of a target 260 that is similar to the target 110 of FIG. 1A except that it forms a stepped front face 206 that approximates the convex front face 106 of FIG. 1A. The transverse width of each step is less than λ_{c}/2. In this case, the stepped front face 206 forms a metasurface in which the laser pulse 102 cannot “see” each step. Instead, the laser pulse 102 responds to the spatial average of the solid-state material, which is convex. Note that when the transverse width of each step becomes greater than λ_{c}/2 and the stepped front face 206 is no longer a metasurface, most of the laser pulse 102 will reflect off each step in the −x direction, which will not result in focusing of the ion beam 118.

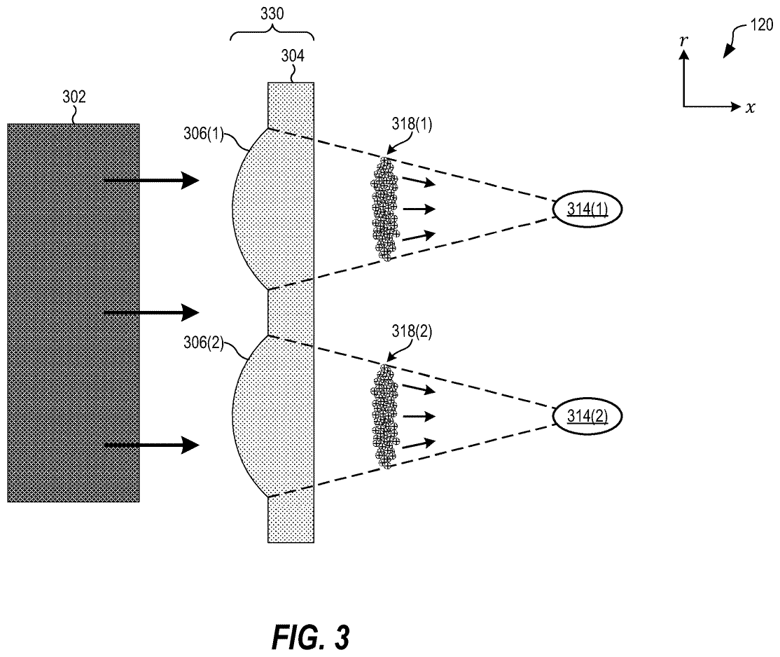

FIG. 3 is a side view illustrating CLIA with a double target 330. In FIG. 3, the double target 330 has a first convex front face 306(1) and a second convex front face 306(2) that is transversely displaced from the first convex front face 306(1). The convex front faces 306(1) and 306(2) share a common substrate 304 that is similar to the substrate 104 of FIG. 1. The convex front faces 306(1) and 306(2) are illuminated by a laser pulse 302 that is similar to the laser pulse 102 of FIGS. 1A-IC except that it has a diameter large enough to illuminate both of the convex front faces 306(1) and 306(2) simultaneously. The interaction of the laser pulse 302 with the first convex front face 306(1) generates, accelerates, and focuses a first ion beam 318(1) onto a first focal point 314(1) while the interaction of the laser pulse 302 with the second convex front face 306(2) generates, accelerates, and focuses a second ion beam 318(2) onto a second focal point 314(2) that is transversely displaced from the first focal point 314(1). The double target 330 may be used to deposit ion energy into two locations of a sample, or two different samples, at the same time.

The concept of the double target 330 can be generalized to n convex front faces 306 that, when simultaneously illuminated by the laser pulse 302, produce n ion beams 318 that are focused onto n transversely separated focal points 314, respectively, where n is an integer greater than or equal to two. While FIG. 3 shows the convex front faces 306(1) and 306(2) having the same focal length, the convex front faces 306(1) and 306(2) may alternatively have different focal lengths (e.g., by having different curvatures).

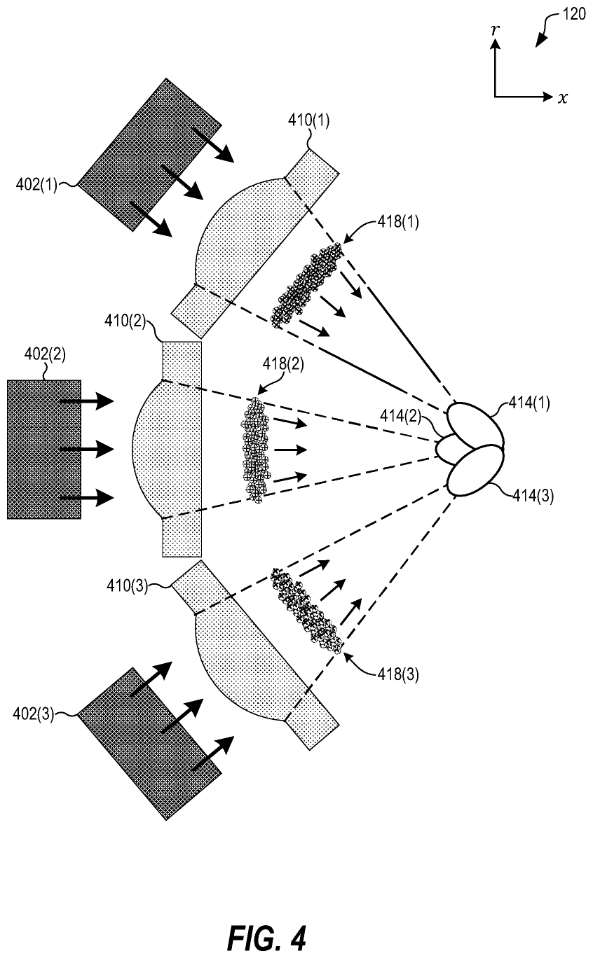

FIG. 4 is a side view illustrating CLIA with several targets arranged with spatially overlapping focal points. Specifically, a first laser pulse 402(1) interacts with a first target 410(1) to generate, accelerate, and focus a first ion beam 418(1) onto a first focal point 414(1), a second laser pulse 402(2) interacts with a second target 410(2) to generate, accelerate, and focus a second ion beam 418(2) onto a second focal point 414(2), and a third laser pulse 402(3) interacts with a third target 410(3) to generate, accelerate, and focus a third ion beam 418(3) onto a third focal point 414(3). Each of the targets 410(1), 410(2), and 410(3) is similar to the target 110 of FIG. 1A. Each of the laser pulses 402(1), 402(2), and 402(3) is similar to the laser pulse 102 of FIG. 1A. As shown in FIG. 4, the focal points 414(1), 414(2), and 414(3) are at least partially overlapped.

While FIG. 4 shows the targets 410(1), 410(2), and 410(3) as being similar to each other, one or more of these targets may be different (e.g., different materials, focal lengths, thicknesses, etc.). Accordingly, the ion beams 418(1), 418(2), and 418(3) may have different types of ions or different ion energies. Similarly, the laser pulses 402(1), 402(2), and 402(3) may have different parameters (e.g., different wavelengths, intensities, waists, etc.).

While FIG. 4 shows CLIA being implemented three times to create three ion beams 418 that are focused onto three overlapping focal points 414, the concept can be generalized to n ion beams 418 that are focused onto n overlapping focal points 414, where n is an integer greater than or equal to two. In some embodiments, the laser pulses 402 are timed to interact with their respective targets 410 such that the ion beams 418 arrive at their respective focal points 414 simultaneously. Such embodiments can advantageously deposit, into a sample located at the overlap of the focal points 414, an ion-beam power that is greater by a factor of n, as compared to using only one ion beam (i.e., n=1). In other embodiments, the laser pulses 402 are timed to interact with their respective targets 410 at different times. These embodiments can advantageously deposit ion energy into the sample at a pulsed rate that is higher by a factor of n, as compared to using only one ion beam.

The present embodiments may be used with other components, devices, and instrumentation known in the art. For example, one or more beam-focusing optics may be used to additionally focus the ion beam 118. The one or more beam-focusing optics may include one or both of a quadrupole magnet and a solenoid. At least one of the one or more beam-focusing optics may have an adjustable focal length. Other components and devices include, but are not limited to, an energy selection aperture, a time-of-flight spectrometer, an ionization chamber, a beam profiler, a dipole chicane, a sample bedding unit, or any combination thereof.

The present embodiments may be used as part of a laser ion accelerator (e.g., a converging-front laser ion accelerator), a proton therapy system, a neutron beam generator, a warm dense matter generator, or an ion radiography system. In some embodiments, any target described herein (e.g., the target 110 of FIG. 1A) is used with a proton beam source. The target includes one or more converter materials such that the proton beam source, when irradiating the one or more converter materials with protons, generates neutrons by nuclear reactions between the protons and the converter materials. Examples of converter materials include, but are not limited to, lithium, beryllium, gold, chromium, or a combination thereof.

### Demonstration

### Results

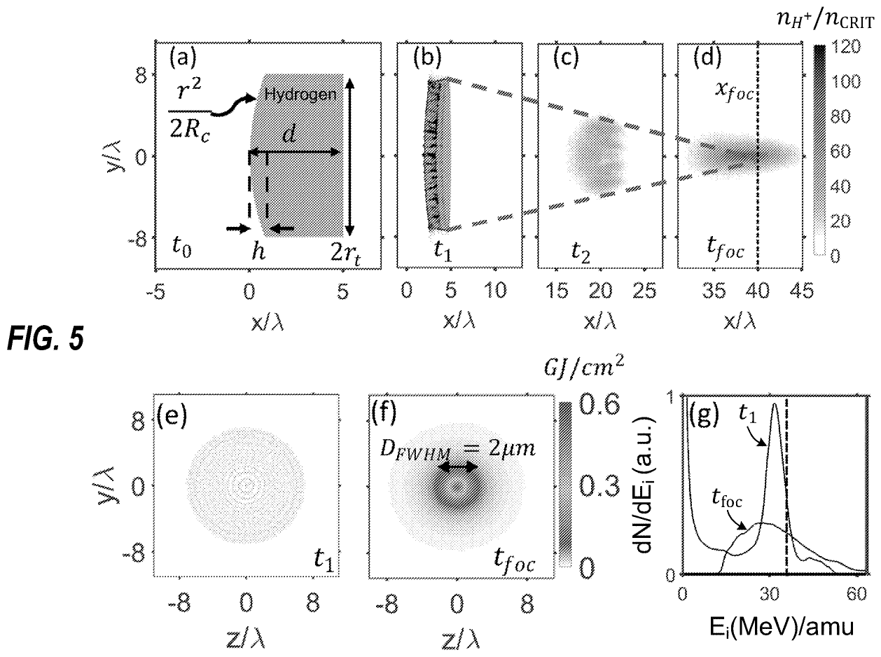

A. 3D PIC simulation: We use Smilei [26], a first-principles three-dimensional (3D) particle-in-cell (PIC) code to self-consistently model the acceleration and focusing of an overdense plasma target by a circularly polarized laser. We refer to this simulation herein as Simulation I. A circularly polarized laser beam with a planar transverse profile and wavelength λ_{L}=1 μm is incident on a hydrogen target with n/n_{crit}=40, or mass density of 0.074 g/cm³, close to liquid/solid hydrogen density. Here,

$${n}_{crit} = {m}_{e} {ω}_{L}^{2} / 4 π {e}^{2} ,$$

where mₑ is the electron mass, ω_{L} is the angular frequency of the laser, and e is the electron charge. The target has a curved front surface defined by x=r²/2R_{c} with R_{c}=40 μm, a transverse radius rₜ=8 μm, a center thickness d=5 μm, and a front bulge with thickness

$$h = {r}_{t}^{2} / ( 2 {R}_{c} ) \approx 0.9 μm ,$$

where c is the speed of light (see panel (a) of FIG. 5). The laser has an intensity I=5×10²¹ W/cm² (a₀=43=E_{L}/E₀, where E_{L} is the amplitude of the transverse laser field and E₀=mcω_{L}/e) with a power P=10 PW incident on the target. The laser longitudinal profile has a \tilde{t}ᵤₚ=tᵤₚ/T₀=1(tᵤₚ=3.3 fs) linear up ramp, a \tilde{t}_{flat}=t_{flat}/T₀=11(t_{flat}=36.7 fs) flat-top region, and a \tilde{t}_{down}=t_{down}/T₀=1(t_{down}=3.3 fs) linear down ramp, where T₀=λ_{L}/c is the single-cycle duration of the laser. A total energy of 400 J is deposited onto the target. The simulation parameters are summarized below in Table 1.

FIG. 5 shows the results of Simulation I. Panels (a)-(d) illustrate the evolution of proton density in the x-y plane at different times. Specifically, panel (a) shows the initial proton density at t₀=0 and the relevant dimensions h, d, rₜ, and R_{c}. Panel (b)-(d) illustrate the proton density at t₁=50 fs, t₂=267 fs, and t_{foc}=483 fs, respectively. Dashed lines in panels (b)-(d) are guides to the eye showing proton focusing. The vertical dashed line in panel (d) is located at x_{foc}=R_{c}. Panels (e) and (f) are plots of ion energy flux J=dEᵢ/dA at t₁ and t_{foc}, respectively. The black arrow in panel (f) shows the FWHM of the energy flux. Panel (g) is a plot of the energy spectra of all ions right after acceleration at t₁≈50 fs and the accelerated ions at the focus at t_{foc}=483 fs. The vertical dashed line in panel (g) is at

$${E}_{k}^{th} \approx 35 MeV .$$

During the initial stage of interaction, the laser pushes on the convex PLI, establishing an interface that accelerates and focuses the ions steadily while moving at a constant velocity v_{b}≈0.14c (see FIG. 5, panel (b)). The PLI velocity agrees with our model. The ions are accelerated to form a monoenergetic spectra with a peak at Eᵢ≈35 MeV, in good agreement with theoretical prediction. The convex shape of the PLI is preserved for almost 2 μm of target shortly after the interaction is terminated at t₁=50 fs. The accelerated ions pass through the un-shocked part of the target during this stage, as evidenced by the ion density increase. We note the transverse striations visible on the PLI (see FIG. 5, panel (b)) arising from the front-surface laser-plasma instability [27-32].

The accelerated ions and the accompanying electron cloud co-propagate as a quasi-neutral plasma after the initial acceleration, contracting transversely and dilating longitudinally (see FIG. 5, panels (b)-(d)). After t_{foc}=483 fs, the ion beam is focused at a distance x_{foc}=40 μm=R_{c}. At the focus, the peak ion density increases to three times its initial value despite the longitudinal dilation. Furthermore, the transverse instability during the initial stage has disappeared due to merging of the different filaments.

The ion beam energy flux increases due to focusing. At t₁, right after the acceleration, the ion-beam energy flux shows a concentric transverse pattern arising from the front-surface transverse instability. The average flux is 0.05 GJ/cm² (see FIG. 5, panel (e)). The quasi-neutral beam propagates and focus in vacuum, with the transverse striations completely disappearing and the peak energy flux increasing to almost 0.6 GJ/cm² (see FIG. 5, panel (g)), with a FWHM of 2 μm. We note that the initially sharp monoenergetic ion peak deteriorates to a wider distribution with the same center at 35 MeV due to the interaction with the neutralizing hot electron cloud (see FIG. 5, panel (g)).

B. Theoretical Description: To interpret CLIA, we adopt simple models based on HB-RPA [6-8] and quasi-neutral plasma evolution in vacuum [33-37]. CLIA consists of two distinct stages: acceleration and coasting. During the acceleration stage, a stream of ions is generated at the parabolic front surface with radially varying focusing velocity. Afterwards, the accelerated ion beam propagates through the pristine part of the target into the vacuum until it reaches the focal point with an accompanying electron cloud; we refer this as the coasting stage.

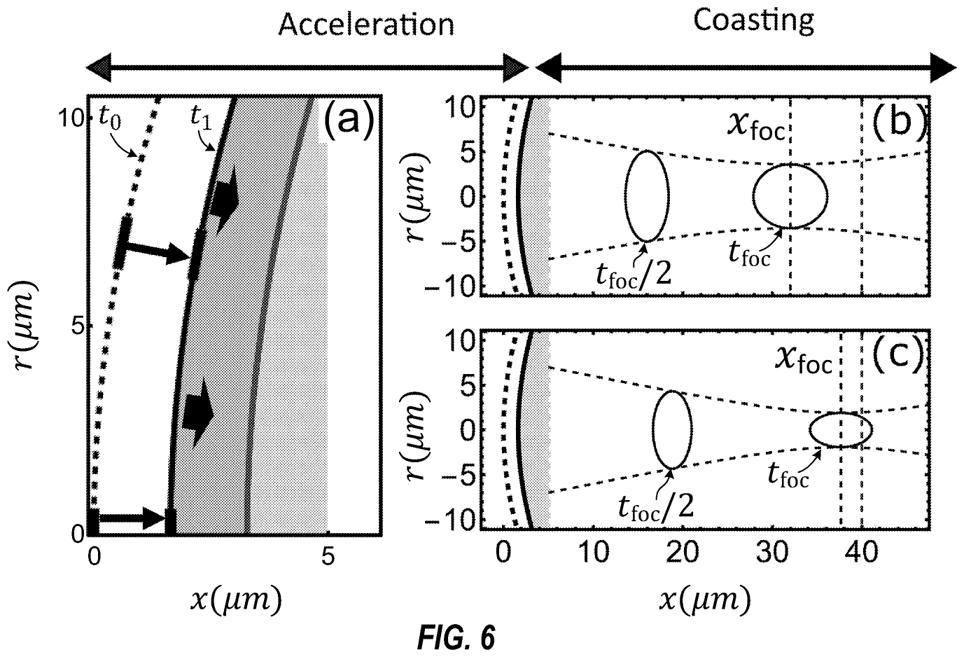

FIG. 6 illustrates the theoretical description of CLIA. Panel (a) shows the acceleration stage from t₀=0 to t₁=12λ_{L}/c, both on-axis and off-axis. Curved lines show the PLI at times t₀ and t₁, respectively. Wide arrows indicate the direction of ion acceleration at t₁. Shading indicates ion density. The right-most curved solid line indicates the position of the leading ions at t₁. Panels (b) and (c) illustrate quasi-neutral beam propagation in vacuum for temperatures Tₑ₁=1.72mₑc²≈880 keV and Tₑ₂=Tₑ₁/4≈220 keV, respectively. In panels (b) and (c), the region x<5 μm is shown as the un-accelerated part of the target. Ellipses show the boundaries of the quasi-neutral plasma at times t_{foc}/2 and t_{foc}. Curved dashed lines indicate the movement of the outer boundary of the quasi-neutral plasma. A vertical dashed line indicates the location x_{foc}. Another vertical dashed line the location of x_{foc} for Tₑ=0. For panels (b) and (c), R_{c}=40 μm and Θ=0.025 (Eᵢ=35 MeV).

We model the acceleration stage by extending the HB-RPA theory. First, we summarize the one-dimensional (1D) HB-RPA mechanism [6-8]. When an intense circularly polarized (CP) laser with intensity I is normally incident on a thick, overcritical plasma having a mass density ρ₀, the plasma electrons are pushed forward via the radiation pressure of the laser, leaving the heavier ions behind. Electrostatic shock forms at the front PLI due to charge separation, moving longitudinally with almost constant velocity and accelerating a steady stream of ions.

The acceleration after PLI formation can be considered a quasi-static process where the outgoing ion momentum flux is balanced by the incoming radiation pressure at the PLI frame. A single parameter Θ=I/ρ₀c³ characterizes the process. Note the alternate definition

$$Θ = {a}_{0}^{2} / \{ ( {m}_{i} / {m}_{e} ) ( {n}_{e} / {n}_{crit} ) \} ,$$

where mᵢ is the ion mass and nₑ is the plasma density. The PLI propagates at a velocity v_{b0}=Cβ_{b0}=c\sqrt{Θ}/(1+\sqrt{Θ}), generating a constant stream of ion beams with velocity

$${v}_{i 0} = 2 {v}_{b 0} / ( 1 + {β}_{b 0}^{2} )$$

and energy Eᵢ/mᵢc²=2Θ/(1+2\sqrt{Θ}).

Since CLIA involves both transverse and longitudinal motion of ions, we extend the HB-RPA theory to a cylindrically symmetric system with two dimensions, r and x. When the laser is incident on the surface at an angle φᵢ, the radiation pressure on the PLI moving with β_{b}=v_{b}/c at an angle φᵢ is

$${P}_{rad} = ( 2 I / c ) {( cos {ϕ}_{i} - {β}_{b} )}^{2} / ( 1 - {β}_{b}^{2} ) .$$

Equating radiation pressure P_{rad} and the outgoing ion momentum, Pₒᵤₜ=γᵢ(mᵢnᵢv_{b})vᵢ with

$${v}_{i} = 2 {v}_{b} / ( 1 + {β}_{b}^{2} ) ,$$

the normalized interface velocity β_{b} can be algebraically solved for:

β_{b}=β_{b0} cos φᵢ. (1)

A surface element located at (x, r) moves with velocity

$$\begin{matrix}{v}_{b} ( r ) = ( \frac{\partial x}{\partial t} {\vec{e}}_{x} , \frac{\partial r}{\partial t} {\vec{e}}_{r} ) \\ = {v}_{b 0} cos {ϕ}_{i} ( r ) \{ cos {ϕ}_{i} ( r ) {\vec{e}}_{x} , sin {ϕ}_{i} ( r ) {\vec{e}}_{r} \}\end{matrix} \qquad ( 2 )$$

and accelerate the ions to speed

$${β}_{i} = {v}_{i} / c = 2 {β}_{b} / ( 1 + {β}_{b}^{2} ) ,$$

where x is the longitudinal coordinate, r is the radial coordinate, and \vec{e}ₓ and \vec{e}ᵣ are the longitudinal and radial unit vectors, respectively.

We first show that the PLI interacting with a plane CP laser can maintain its shape throughout the interaction. PLI is described by x(r, t), with its evolution written as dx(r, t)/dt=∂ᵣx∂ₜr+∂ₜx. Using Eqn. 2, we find that the evolution of PLI is only dependent on the following equation:

$$\frac{dx ( r , t )}{dt} = {v}_{b 0} ( r , t ) . \qquad ( 3 )$$

Even though the PLI undergoes evolution in the (r, x) plane, the net evolution can be described by v_{b0}(r, t), which in turn only depends on the instantaneous laser intensity at time t and radial position r. We note that this is a general result applicable to laser with radial spatial dependence interacting with an overdense plasma boundary.

The PLI shape can be described throughout the interaction by Eqn. 3 (see FIG. 6, panel (a)). In particular, if the laser transverse intensity throughout the entire target is constant and planar, the PLI moves at a constant longitudinal velocity v_{b0} throughout the interaction. The ions are accelerated perpendicular to PLI surface with velocity

vᵢ(r)=vᵢ{cos φᵢ(r)\vec{eₓ},−sin φᵢ(r)\vec{e}ᵣ}, (4)

which has a transverse-focusing velocity component. These ions move ahead of the PLI (see FIG. 6, panel (a), shaded region) at approximately twice the PLI speed.

Using the above result, we show that using a parabolic PLI can focus the ions at a well-defined focal length. The incidence angle φᵢ for a parabolic PLI defined by x=r²/(2R_{c}) is given by φᵢ=arctan(r/R_{c}). For r<<R_{c} (φᵢ<<1), the ion velocity can be approximated by

$${v}_{i} ( r ) \approx \frac{2 {v}_{b 0}}{1 + {β}_{b 0}^{2}} ( {\vec{e}}_{x} , - \frac{r}{{R}_{c}} {\vec{e}}_{r} ) . \qquad ( 5 )$$

Under this small angle approximation, different PLI elements propagate with a transverse angle given by φᵢ=vᵣ/vₓ=−r/R_{c}. All the different elements focus on axis at time

$${t}_{foc} = r / ( {v}_{i} \cdot \vec{{e}_{r}} ) \approx \frac{{R}_{c}}{2 {v}_{b 0}} ( 1 + {β}_{b 0}^{2} ) \qquad ( 6 )$$

and focal length

x_{foc}=t_{foc}×(vᵢ·\vec{e}ₓ)=R_{c}. (7)

Under the small angle approximation, the kinetic ion energy Eᵢ differs negligibly from the 1D theoretical estimate. Consequently, the Θ parameter from the 1D theory can be used to estimate the ion energy. For example, the monoenergetic ion beam energy is well estimated by using Θ=0.025 in Eᵢ/(mᵢc²)=2Θ/(1+2\sqrt{Θ})≃35 MeV (see FIG. 5, panel (g)).

After the acceleration, the ions are accompanied by a neutralizing electron cloud. When the ions exit the plasma slab and propagate in vacuum, they can be considered as a cold ion beam accompanied by a hot electron cloud in the coasting stage. Analytic description of such quasi-neutral plasma evolution in vacuum have been studied by several authors [33-37]. In particular, an adiabatically evolving quasi-neutral electron-ion plasma's characteristic length scales lₖ(t) can be described by simple equations in the nonrelativistic limit [34, 35, 37]. We reproduce the relevant equations from Ref. [35] below:

$${l}_{k}^{2} ( t ) = {[ {l}_{k} ( 0 ) + {\dot{l}}_{k} ( 0 ) t ]}^{2} + {c}_{k}^{2} {t}^{2} . \qquad ( 8 )$$

### Here,

$${c}_{k}^{2} = ( {Zm}_{e} {{V}_{k}^{e} ( 0 )}^{2} + {m}_{i} {{V}_{k}^{i} ( 0 )}^{2} ) / ( {m}_{i} + {Zm}_{e} )$$

defines the ion acoustic velocity cₖ in the k^{th} direction, with lₖ the characteristic length-scale in the k^{th} direction, mᵢ the ion mass, and

$${V}_{k}^{( i , e )}$$

the ion/electron root mean square velocity in the k^{th} direction.

CLIA generates ion beams with a single well defined \dot{l}ᵣ(0) since the contracting velocity is proportional to the distance away from axis and the ions focus at a well defined t_{foc}. We first note that if the plasma is cold (i.e., cₖ=0), the quasi-neutral plasma beam can contract to almost a singular point at time

$${t}_{foc}^{0} = {l}_{r} ( 0 ) / {\dot{l}}_{r} ( 0 ) .$$

For finite-temperature plasma, the time t_{foc} to contract to minimum transverse size

$${l}_{r}^{min}$$

are as follows:

$${l}_{r}^{min} = \frac{{c}_{κ} {l}_{r} ( 0 )}{\sqrt{{c}_{k}^{2} + {{\dot{l}}_{r} ( 0 )}^{2}}} = {c}_{k} \sqrt{- \frac{{l}_{r} ( 0 )}{{\dot{l}}_{r} ( 0 )} {t}_{foc}} , \qquad ( 9 )$$

$${t}_{foc} = - \frac{{l}_{r} ( 0 ) {\dot{l}}_{r} ( 0 )}{{c}_{k}^{2} + {\dot{l}}_{r}^{2} ( 0 )} . \qquad ( 10 )$$

For visualization, we consider an ellipsoidal plasma moving and contracting as it propagates. The plasma moves with longitudinal velocity vₓ(0)/c=0.25 with lₓ=1 μm, lᵣ(0)=8 μm, \dot{l}ᵣ(0)=vₓ(0)lᵣ/R_{c}, \dot{l}ₓ(0)=0.05vₓ, with R_{c}=40 μm. The plasma includes cold hydrogen ions and electrons with different temperatures. We have chosen parameters are comparable to that from Simulation I. Specifically, for the result in FIG. 6, panel (b), we prescribed Tₑ₁=880 keV which was extracted from Simulation I. The plasma contracts maximally at a shorter focal length with larger transverse radius of lᵣ=3.7 μm, forming an elongated ellipse as was observed in Simulation I (see FIG. 5). We note that if the electron temperature is lower (Tₑ₂=220 keV), the plasma focuses at a longer focal length with smaller radius of lᵣ=1.7 μm (see FIG. 6, panel (c)). The lower thermal pressure of the electrons can lead to better focusing of the beam. Conversely, for very long focal length, cₖ>>\dot{l}ᵣ(0),

$${l}_{r}^{min} \approx {l}_{r} ( 0 ) ,$$

which can result in negligible plasma contraction.

Our simplified model belies several complex effects present in laser-plasma interaction. The surface layer electrons are heated to a finite temperature [39-41], and the surface can undergo transverse instabilities that can perturb the PLI surface [27-32, 39, 40] (see FIG. 5, panel (b)). Furthermore, the quasistatic acceleration process is accompanied by small-scale transverse oscillations around the equilibrium velocity of the PLI [7, 8].

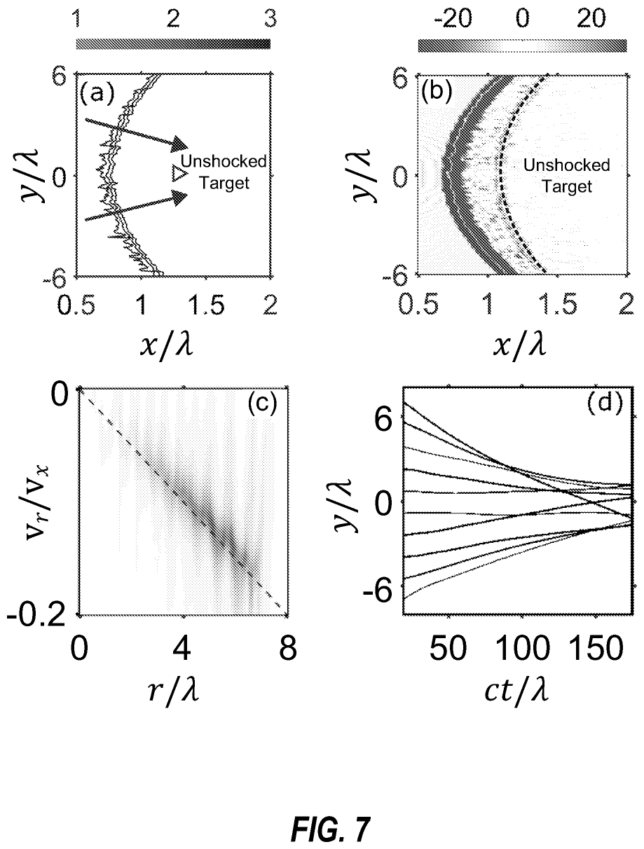

FIG. 7 illustrates field structure and ion beam propagation for CLIA. Panel (a) is a plot of the normalized electric potential

$$\tilde{Φ} = - {Φ}_{0}^{- 1} {\int }_{∞}^{x} {E}_{x} dx = 1 , 2 , 3 ,$$

(Φ₀=E₀λ_{L}=3.2 MV) 16 fs after the laser hits the front surface. Panel (b) is a plot of the net charge density (nₕ−nₑ)/n_{crit} 16 fs after the laser hits the front surface. The arrows in panel (a) indicate the direction of ion acceleration. Panel (c) is a plot of the ion phase-space distribution at 50 fs. The dashed line shows vᵣ/vₓ=−r/R_{c}. Panel (d) is a plot of transverse ion position versus time for selected ions. See Table 1 below for the simulation parameters.

To confirm that our model can adequately describe the acceleration process, we compare it with additional results from Simulation I. The electric potential exhibits a parabolic shape 16 fs after the laser starts interacting with the target (see FIG. 7, panel (a)). While there are perturbations on the electric potential arising from the transverse PLI instability, the potential still accelerates and focuses the ions. The well-localized electric potential coincides with the double layer of electrons moving ahead of ions, with the parabolic shape maintained (see FIG. 7, panel (b)). We note that the ions accelerated earlier maintain good charge neutrality compared to the front PLI despite showing some low-density perturbations, and that the PLI effectively sweeps up the ions and electrons, leaving negligible charge behind.

As a result of these PLI-generated fields, the accelerated ions gain a transverse focusing velocity that is dependent on the radial position (see FIG. 7, panel (c)) at t₁≈50 fs after the end of acceleration process, which is in good agreement with the prediction given by vᵣ/vₓ=−r/R_{c} from Eqn. 5, despite the perturbations caused by the transverse instability. After propagating through few micron of unshocked material, the ions and the neutralizing hot electrons co-propagate during the coasting stage. The hot electron cloud exerts a transverse pressure bending the ion beams away from the axis, evidenced by slight bending of the ion trajectories (see FIG. 7, panel (d)).

### Dependence on Laser-Plasma Parameters

In our theoretical description, the acceleration stage of CLIA depends on only two independent parameters: the focal length R_{c} and the dimensionless parameter Θ. The acceleration dynamics dependent on Θ, such as total charge, energy, and conversion efficiency, can be estimated using the 1D HB-RPA model without affecting the focal length R_{c}. This lends CLIA available to a wide range of laser-plasma parameters without having to compromise R_{c}. We validate these predictions using PIC simulations, and also identify regimes where the model fails to hold.

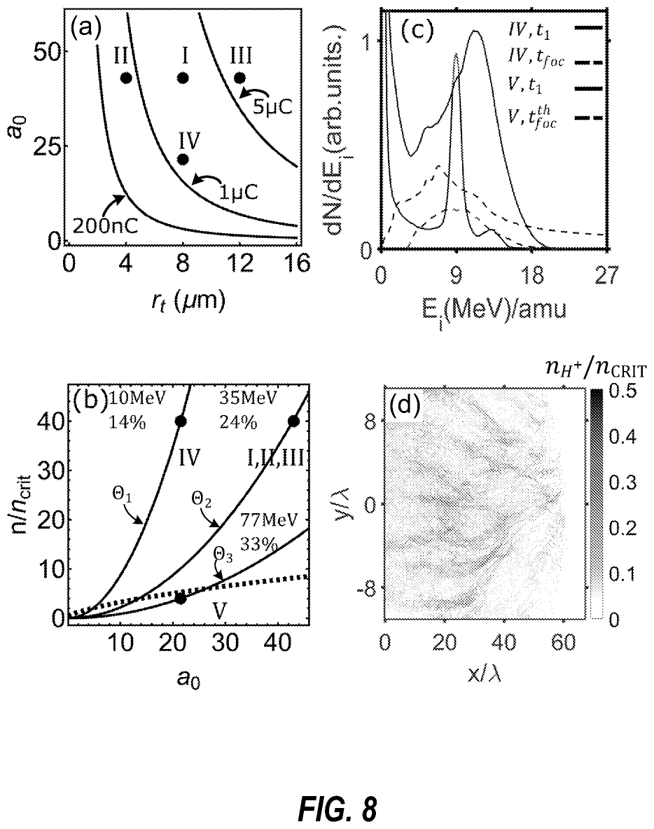

FIG. 8 illustrates the dependence of CLIA on laser-plasma parameters. Panel (a) is a plot of theoretical estimates for accelerated charge versus target dimension and laser intensity for tₗₐₛₑᵣ=40 fs and hydrogen target density nᵢ=4.5×10²² cm⁻³. The lines in panel (a) are equi-charge contours from Eqn. 11. The dots in panel (a) indicate target and laser parameters from simulations. Panel (b) is a plot of theoretical ion energy as a function of plasma density n/nc_{crit} and laser field strength a₀. The dashed line indicates the boundary between classical hole boring and incomplete hole boring. The solid lines indicate Θ₁=0.025, Θ₂=0.063, and Θ₃=0.25. The dots indicate parameters corresponding to the simulations. Panel (c) is a plot of ion energy spectra for Simulations IV and V. Solid lines shows ion-energy spectra after t₁50 fs. Dashed lines indicate ion-energy spectra after t_{foc}=983 fs for Simulation IV and

$${t}_{foc}^{th} = 400 fs$$

for Simulation V). The results for Simulation V are multiplied by 10 for visualization. Panel (d) is a plot of x-y plane density for Simulation V at

$${t}_{foc}^{th} .$$

See Table 2 for simulation parameters.

We first confirm the independence of ion spectra and focal length R_{c}. We perform two additional simulations with R_{c}=20 μm and 60 μm, denoting them Simulations II and III, respectively. Here we modify both the target focal length R_{c} and the target radius rₜ. Specifically, rₜ=0.2R_{c} such that r/R_{c}<<1 holds. The laser intensity, duration, and target density are same as that in Simulation I. The mean energy of the ions after the acceleration is close to 35 MeV for both simulations, demonstrating the mean ion energy is independent of focal length. The ions are focused to a much smaller radius than the initial target radius at their respective t_{foc} and x_{foc} for both simulations, showing that indeed the 1D theory holds independently of R_{c}.

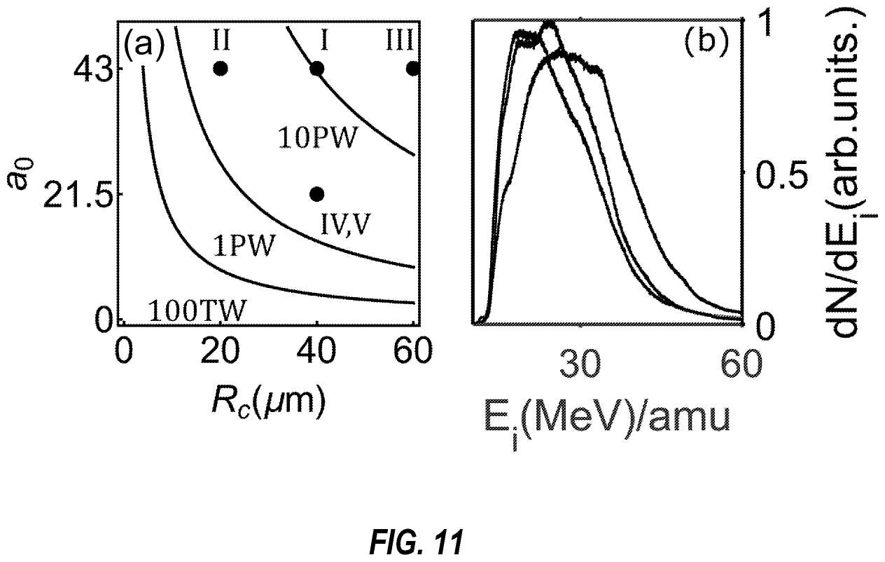

This also enables connecting the on-target power with laser peak intensity (see FIG. 11, panel (a)): the on-target powers of simulations II and III are 2.5 PW and 40 PW, respectively, demonstrating that a wide range of laser power can be used for CLIA scheme. It is also possible to use lower laser intensity, as will be discussed below.

Leveraging the validity of the 1D theory for CLIA, we can also estimate the accelerated charge after the laser finishes interacting with the PLI. Assuming the laser with duration tₗₐₛₑᵣ=40 fs and ion density nᵢ=4.5×10²² cm⁻³ (ρ=0.74 g/cm³), the accelerated ion charge can be estimated by

$$Q \approx \vert e \vert {n}_{i} π {r}_{t}^{2} {d}_{accel} , \qquad ( 11 )$$

with d_{accel}=cv_{b0}t_{L}/(c−v_{b0}) the thickness of the accelerated target and nᵢ the hydrogen-ion density (see FIG. 8, panel (a)). The theoretical estimates for the total accelerated charge,

$${Q}_{th}^{II} = 0.7 μ C ,$$

$${Q}_{th}^{I} = 2.7 μ C ,$$

$${Q}_{th}^{III} = 6.1 μ C$$

are in qualitative agreement with total ion charge calculated ahead of the rear of the target (x>5 μm) at t=100 fs,

$${Q}_{exp}^{II} = 0.5 μ C ,$$

$${Q}_{exp}^{I} = 2.3 μ C ,$$

$${Q}_{exp}^{III} = 5.3 μ C .$$

By changing the laser intensity or plasma density, the mean energy to which the ions are accelerated can be changed while keeping the focal length same [6, 7]. Since rₜ<<R_{c} guarantees the applicability of 1D theory, changing the parameter Θ enables control of mean energy to which the ions are accelerated. As shown in FIG. 8, panel (b), the curves characterizing different values of Θ in the (n/n_{crit}, a₀) plane determine the mean energy to which the ions are accelerated.

To demonstrate this, we perform simulation IV using the same target as simulation I, but with ¼th the laser intensity and 2.5 PW of laser power incident on the same target. The ion beam is accelerated to E₁≃9 MeV, close to the theoretically expected value of 10 MeV. The ions propagate with slower velocity, leading to longer t_{foc}=900 fs, more than twice that of simulation I. However, the radius to which the ions are focused is comparable to that of simulation I; lower laser intensity heats the electrons to a lower temperature of Tₑ≈150 keV, almost ⅙th of that of Simulation I, and the lower thermal pressure compensates for the longer focal length and focusing time, leading to comparable focusing as that from Simulation I, and showing similar widening of energy FWHM. We also note that estimate for accelerated charge still as above still holds in this case (see FIG. 8, panel (a)), showing qualitative agreement between

$${Q}_{th}^{IV} = 1.4 μ C$$

$$and$$

$${Q}_{exp}^{IV} = 1.2 μ C .$$

The scaling in FIG. 8, panel (b) may suggest that by keeping the laser intensity same but reducing the mass-density of the target, the ion beam energy can be increased indefinitely. This is true in the “classical” hole-boring regime where the charge separation can balance the radiation pressure. However, there exists a different acceleration regime for thick targets, where the energy balance, not the momentum balance governs the hole-boring process. This transition to “incomplete hole-boring” can occur when the electrostatic force cannot balance the radiation pressure. For hydrogen plasmas, this boundary between classical and incomplete hole boring regime is identified by the equation [42]

$${n}_{b} \approx 0.618 {( 1 + {a}_{0}^{2} )}^{0.314} {n}_{crit} . \qquad ( 12 )$$

For nₚ<n_{b} (i.e., below the dashed line in FIG. 8, panel (b)), the PLI becomes unstable, unlike in the classical HB-RPA regime, and is incapable of maintaining a stable shape. The ions are accelerated to a higher energy at the expense of beam quality [43], and the CLIA scheme becomes inapplicable in this regime.

We demonstrate this with Simulation V using a much lower density plasma density with n/n_{crit}=4 or mass density of 7.4 mg/cm³ using the same 2.5 PW laser. As previously discussed, the radiation pressure in cannot be balanced by the electrostatic force from charge separation. The accelerated ion spectra peak is located at a much smaller energy than that predicted by classical theory [6-8], with larger energy spread (see FIG. 8, panel (c)). The electrons are also heated to a very high temperature, drastically increasing the ion energy spread. Furthermore, the formed PLI is unable to focus ions, and the accelerated ions occupy a much larger volume with low density (see FIG. 8, panel (d)), with no sign of focusing. Furthermore, the extremely unstable PLI makes the estimate on total charge Q inapplicable.

Finally, we comment on the power required to demonstrate CLIA. Already from extrapolating the results from FIG. 8, panel (b), and FIG. 11, panel (a), the on-target intensity of 0.63 PW is predicted for a focal length of R_{c}=20 m and a₀=21.5. We have observed in the simulations that even lower intensity lasers with a₀10 and I=2.7×10²⁰ W/cm² can be used. Combined with shorter focal length of R_{c}=20 μm resulting in rₜ=4 μm, proof-of-principles experiments of CLIA may even be possible with 100 TW class lasers [44], which are more accessible than multi-petawatt systems.

### Discussions

Up until now, we limited our discussion to planar laser (homogenous laser intensity) and hydrogen-only targets. We discuss the implications of using lasers with radially dependent transverse profile (e.g., Gaussian, super-Gaussian) and targets with multiple ion species, demonstrating the applicability of CLIA to generate ultra-low emittance multi-ion beams.

A. Effect of Laser and Target Transverse Geometry: Practically, the available high-power lasers have transversely inhomogeneous profiles (e.g., Gaussian, super-Gaussian, etc.). This effect is especially detrimental in flat targets interacting with Gaussian lasers, increasing the transverse dimension of the accelerated ion beam [4, 9]. We demonstrate that it is possible to combat this effect by using our curved-front target. We also discuss the advantage of using a laser pulse with flatter intensity (e.g., super-Gaussian).

We revisit the simple model presented above to describe the PLI evolution with inhomogeneous laser intensity profiles. The front PLI shape is determined by the initial target front shape and the laser transverse profile. A gaussian pulse whose amplitude is given by

$$a ( r ) = {a}_{0} exp ( - {r}^{2} / {σ}_{1}^{2} ) ,$$

has a radially dependent hole-boring velocity dependent on the transverse coordinate r:

$${v}_{b}^{g} ( r ) = \frac{\sqrt{{Θ}_{0}} exp ( - {r}^{2} / {σ}_{1}^{2} )}{1 + \sqrt{{Θ}_{0}} exp ( - {r}^{2} / {σ}_{1}^{2} )} . \qquad ( 13 )$$

For an initially flat target with x(r, 0)=0, the front PLI shape near axis r<<σ₁ evolves according to

$${v}_{b}^{g} ( r ) \approx \sqrt{{Θ}_{0}} ( 1 - {r}^{2} / {σ}_{1}^{2} ) ,$$

and the off-axis elements interacting with lower intensity falls behind, making the PLI shape concave (dr/dx>0). Since the ions are always accelerated perpendicular to the PLI, this results in a transversely diverging ion beam.

For a parabolic initial surface, x(r, 0)=r²/2R_{c}, the PLI can be described near axis (r<<σ₁) by

$$x ( r , t ) \approx \frac{{r}^{2}}{2 {R}_{c}^{1} ( t )} + {v}_{b 0} t , \qquad ( 14 )$$

$${R}_{c}^{1} ( t ) = {{R}_{c} [ 1 - \frac{2 {R}_{c} {v}_{b 0} t}{{σ}_{1}^{2} ( 1 + \sqrt{Θ} )} ]}^{- 1} . \qquad ( 15 )$$

The quadratic front surface of a target interacting with a gaussian laser will initially focus ions to a time-varying focal length

$${R}_{c}^{1} ( t )$$

which increases over time. The PLI become flatter and eventually flip sign at time and distance

$${t}_{flip} = \frac{{{σ}_{1}^{2} ( 1 + \sqrt{Θ} )}^{2}}{2 c \sqrt{Θ} {R}_{c}} , {x}_{flip} = \frac{{σ}_{1}^{2} ( 1 + \sqrt{Θ} )}{2 {R}_{c}} . \qquad ( 16 )$$

Afterwards, the accelerated ions will start diverging, limiting the flux of ions that can be focused.

For a given constant-intensity laser (i.e., constant Θ) and fixed laser duration t_{L}, we can also estimate the minimal laser spot-size and the smallest theoretical spot size to which the ions can focus (assuming Tₑ≈0). To avoid large focal length

$${R}_{c}^{1} ( t )$$

variation, we can require

$${t}_{push} = \frac{c}{c - {v}_{b 0}} {t}_{L} ≪ {t}_{flip} .$$

Note that tₚᵤₛₕ>t_{L} because the front of the laser bores hole through the target. This leads to laser spot size requirement for focusing to be effective:

$${σ}_{1}^{2} ≫ 2 {R}_{c} {v}_{b 0} {t}_{L} . \qquad ( 17 )$$

The minimal ion spot size can be also estimated from

$${R}_{c}^{1} ( t ) ,$$

provided r<<σ₁ holds. For t_{foc}>>tₚᵤₛₕ, the ion focusing can be attributed to variation of PLI curvature

$${R}_{c}^{1} ( t ) .$$

The ions that were accelerated first and last have a focal length difference, resulting in transverse spread given by

$$\frac{{r}_{min}}{{r}_{t}} = ( 1 - \frac{{R}_{c}}{{R}_{c}^{1}} ) = \frac{2 {R}_{c} {v}_{b 0} {t}_{L}}{{σ}_{1}^{2}} . \qquad ( 18 )$$

As the laser intensity profile becomes flatter (σ₁→∞), tₗₐₛₑᵣ→∞, rₘᵢₙ→0, and such effects were avoided in our previous simulations using a planar laser.

Alternatively, a laser with a super-Gaussian transverse profile can mitigate this effect. For example, we consider PLI interacting with a fourth-order super-Gaussian laser pulse with transverse amplitude written as

$$a ( r ) = {a}_{0} exp ( - {r}^{4} / {σ}_{2}^{4} ) .$$

This results in a hole-boring velocity near axis (z⁴<<σ⁴),

$${v}_{b}^{sg} ( r ) \approx \frac{\sqrt{Θ}}{1 + \sqrt{Θ}} + O ( \frac{{r}^{4}}{{σ}_{2}^{4}} ) . \qquad ( 19 )$$

Unlike the PLI interacting with Gaussian transverse profile, the surface does not flip its curvature near axis, enabling acceleration and focusing of a larger flux of ions.

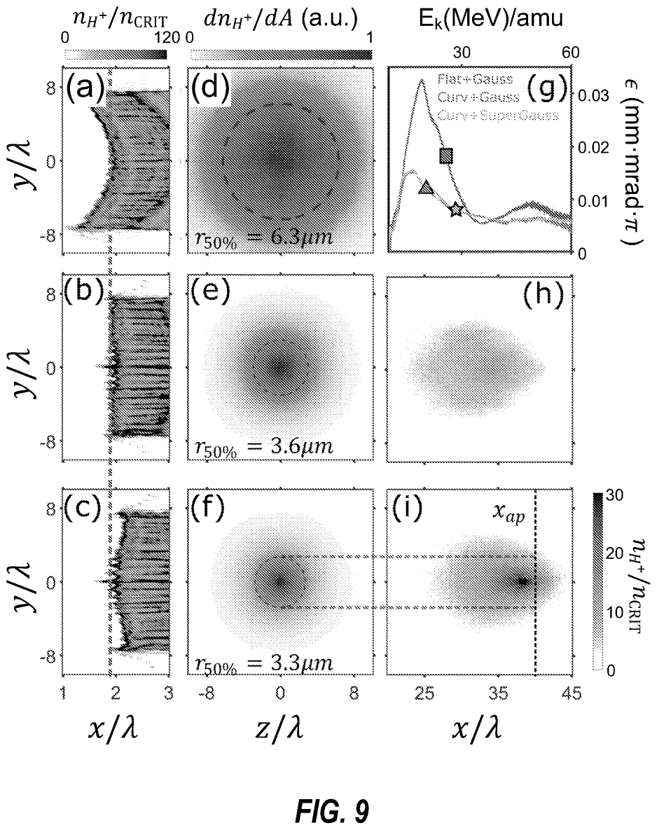

FIG. 9 is a comparison of target front shape and laser transverse profile. Panel (a) is an x-y plane density profile for a flat target and Gaussian laser (Simulation VI). Panel (b) is an x-y plane density profile for a curved target and Gaussian laser (Simulation VII). Panel (c) is an x-y plane density profile for a curved target and super-Gaussian laser (Simulation VIII). The vertical dashed line in panels (a)-(c) indicate x_{flip}=1.8 μm. Panels (d)-(f) are plots of the number of ions passing the y-z plane at xₐₚ=40 μm for Simulations VI, VII, and VIII, respectively. Here, the dashed lines are a contour encompassing 50% of all ions. Panel (g) is a plot of the emittance of the accelerated ions within r_{50%} for Simulations VI, VII, and VIII at t_{foc}=483 fs. The shapes in panel (g) indicate location of peak energies for Simulation VI (square), Simulation VII (triangle), and Simulation VIII (star). Panel (i) is an x-y plane density plot for Simulation VIII. Here, the vertical cashed line indicates the location of virtual screen xₐₚ used in panels (d)-(f). The horizontal dashed lines in panels (f) and (i) map the aperture size in panel (f) to the aperture location in panel (i). Simulation parameters are listed in Table 2.

We verify the above predictions using 3D PIC simulations. First, we examine the effect of a Gaussian laser in accelerating a flat target (Simulation VI). The on-axis intensity is kept same to that from Simulation I. I=5×10²¹ W/cm², with σ₁=11.3 μm corresponding to 10 PW of total laser power, with other parameters kept the same. The target is a cylinder with flat front surface at x=0 μm extending to x=5 μm with rₜ=8 μm. After t₁=50 fs, the PLI shows a clear concave shape (see FIG. 9, panel (a)) which accelerates diverging ion beams. In comparison, when the same Gaussian laser is incident on a convex front surface as that used in Simulation I (Simulation VII), the PLI becomes almost flat at x=1.8 μm after t₁=50 fs (see FIG. 9, panel (b)), in close agreement with x_{flip}=1.8 μm and t_{flip}=45 fs. Consequently, all the ions accelerated up to this point will converge, albeit to varying focal lengths, ranging from R_{c}=49 μm to R_{c}=∞. Finally, using the same power (10 PW) laser with a super-Gaussian transverse profile (σ₂=10.1 μm) on the convex target keeps the front surface shape convex (see FIG. 9, panel (c)), and ions accelerated by the PLI have focal length R_{c}≈40 μm.

To further quantify the degree of ion focusing, we define a virtual screen located around the theoretical focal point of x=R_{c}=40 μm (see FIG. 9, panel (i)) in the y-z plane. The ion distribution's radial extent in the screen is markedly smaller for the curved targets (see FIG. 9, panels (d)-(f)). We define r_{50%} as the radius that 50% of the accelerated pass through (see FIG. 9, panels (f) and (i)). The “ion count” in the virtual screen shows that using the curved target can focus the ions to almost half the radius for both the gaussian and super-Gaussian laser (see FIG. 9, panels (d)-(f)), reducing the r_{50%} from 6.3 m in Simulation IV to 3.6 μm for Simulation VII and 3.3 μm for Simulation VIII. We also note the effect of a Gaussian laser profile on ion focusing (see FIG. 9, panel (h)). The longitudinal dilation is larger and the peak on-axis density is markedly smaller.

The convex target and super-Gaussian laser also improves beam quality. Significant emittance reduction in seen for CLIA. At t_{foc}=483 fs, the beam emittances at the peak of energy spectra is largest for the Simulation VI with the flat target and Gaussian laser profile with 0.021 mm·mrad·π, as opposed to Simulation VII's 0.012 mm·mrad·π and Simulation VIII's 0.008 mm·mrad·π (see FIG. 9, panel (g) and FIG. 11, panel (b)). We also note that the super-Gaussian laser has the largest on-target power, resulting in the highest ion energy (see FIG. 11, panel (b)).

### B. Multispecies Ion Target Acceleration:

HB-RPA can accelerate multiple ion species to a similar energies [4], making it suitable for applications that require acceleration of heavier ions [16, 17, 45]. Since the stopping distances for heavier ions have much sharper Bragg peaks than hydrogen [45], these can be a promising alternative for applications such as cancer therapy, which benefit from localized energy deposition.

Another point of interest is the coupling strength difference of such ions to the accompanying electron cloud, which can then in turn affect the beam quality. As shown in the above single-ion-species plasma simulations, the initially monoenergetic beam quality deteriorates during the coasting stage due to the thermal pressure of the accompanying electron cloud. While the hot electrons accelerate some of the ions to higher energy (e.g., see FIG. 5, panel (g)), this is not desirable in the context of beam quality preservation, especially if monoenergetic energy spectra are required.

In a multi-ion plasma, the lighter ions with higher charge-to-mass ratio are more strongly coupled to the hot electron cloud in comparison to lower charge-to-mass ratio ions [34]. By using a target composed of carbon and hydrogen, one can preferentially “accelerate” the hydrogen during the coasting stage, while keeping the carbon spectra relatively intact [34].

We verify the above predictions using a target composed with CH₁₂ (Simulation XI). By number, the ratio is 1:12 and by mass the ratio is 1:1. The target shape is the same as in Simulation I, with the same mass-density of 0.074 g/cm³ and the charge-density adjusted accordingly. Similarly, a planar laser as that in Simulation I is used.

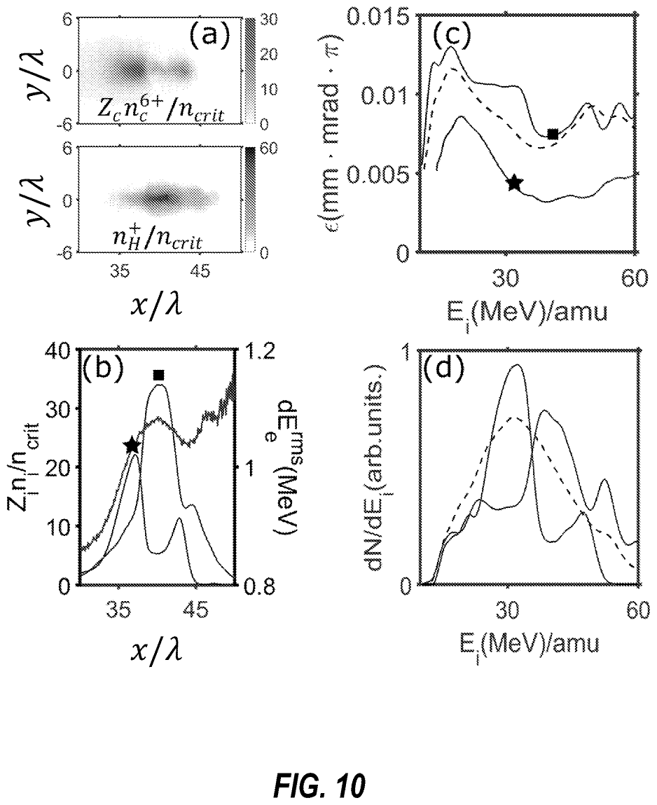

FIG. 10 illustrates multispecies CLIA simulation results at t_{foc}=483 fs for a CH₁₂ target (Simulation IX). Carbon and proton charge density in x-y plane. Panel (b): On-axis charge density for carbon (Orange) and proton (Green), (left axis). Electron root mean square kinetic energy over longitudinal position (right axis). Panels (c) and (d): Emittance (c) and energy spectra (d) with respective r_{50%} measured at xₐₚ=40 μm for carbon, hydrogen, and hydrogen-only Simulation I (dashed). Star (Square) in (b-c) corresponds to positions in the respective axis for carbons (hydrogen) highest energy peak in (d). Simulation parameters: On-target power: 10 PW, same target shape and mass-density as Simulation I, with C:H=1:12. Also See Table 2.

Our simulation confirms that both ion species are accelerated to similar velocities (or energy per atomic mass units) and also gain a focusing transverse velocity distribution similarly to Simulation I during the acceleration stage (t₁=50 fs). Afterwards, the ion species undergo distinct evolutions. While both species contract transversely, they form distinct distributions longitudinally at t_{foc} (see FIG. 10, panels (a) and (b)). The accelerated hydrogen ions are almost homogeneously elongated while the carbon ions form a double-peak structure, with a large population of carbon ions trailing the hydrogen. At the focus, the hydrogen ions form an elongated oval-like structure while the carbons form two longitudinally separated peaks, with the majority of the carbons occupying a small longitudinal and transverse dimension with high density.

The hot electron cloud neutralizing the ions have a root-mean-square kinetic energy

$${E}_{e}^{rms}$$

dependent on their longitudinal position, with higher energy electrons moving ahead of the ions and lower energy electrons lagging behind (see FIG. 10, panel (b)). Furthermore, there is a local energy peak coinciding with the hydrogen ions, while the carbon ions occupy regions with lower energy electrons, showing that hydrogen ions couple more with the hot electron cloud.

To quantify the beam quality, we employ a similar metric as above, using a virtual screen placed at x=40 μm. The carbons occupy a smaller area on the screen with

$${r}_{50 \%}^{C} = 2.1 μm ,$$

compared to that of hydrogen

$${r}_{50 \%}^{H} = 3 μm .$$

We note that

$${r}_{50 \%}^{H} = 3 μm$$

is slightly larger than the hydrogen-only target result (2.8 μm) in Simulation I. This difference is reflected in the ions' emittance and energy spectra within their respective r_{50%} at t_{foc}. The hydrogen emittance is 0.007 mm·mrad·π, which is comparable to the corresponding quantity from Simulation I. However, the carbon ion emittance is 0.004 mm·mrad·π, almost half that of carbon ions (see FIG. 10, panel (c)). We also note that the energy peaks of the ion spectra occupy distinct locations in energy, with hydrogen ions having the largest peak at 40 MeV while the carbon ions have peak at 33 MeV, closer to that derived from the Θ parameter. This is in contrast to the single-peaked energy distribution of Simulation I result, showing that the hydrogen ions gain energy from the hot electron cloud preferentially during the coasting stage.

### Conclusion and Outlook

Ion beams generated by CLIA are of broad technological interest. Several of these beams combined may be a energy-efficient way to ignite a dense ICF target via fast ignition [15]. The ultra-low emittance also makes these beams a promising candidate for cancer therapy [46]. The capability of focusing the ion beams in-situ and increasing the ion flux makes these beams for many other applications requiring high energy-flux beams focused to a small volume such as generation of warm dense matter [11] or neutron production [47, 48].

### Simulation Details

In this section, we summarize the simulation details for Simulation I (see Table 1 below) and outline the relevant parameters for Simulations I-IX and the parameters Θ and Eᵢ from the 1D HB-RPA theory (see Table 2). The possible laser powers for demonstrating CLIA can span several orders of magnitude, from 100 TW (or less) to over 10 PW (or more), by modifying the focal length and laser intensity. A lower-power implementation using a 100-TW-class laser may be used for prototyping purposes in existing laser facilities. We note that the results are applicable to different laser wavelengths. Systems such as the ALEPH 400-nm laser [51] may be relevant for CLIA provided that the plasma densities and focal length are scaled accordingly. A carbon-only target with n/n_{crit}=40 for such lasers would have mass-density of 0.94 g/cm³, enabling the use of solid-density targets. However, the fabrication requirements may become more stringent such that target imperfections become smaller than the laser wavelength.

Panel (a) of FIG. 11 is a contour plot showing estimates of on-target powers Pₜ as a function of laser field strength a₀ and focal length R_{c} assuming rₜ=R_{c}/5 and a plane-wave laser. Panel (b) of FIG. 11 is a plot of energy spectra of accelerated ions within r_{50%} for Simulations VI, VII, and VIII at t_{foc}=483 fs. Different front surface curvature and laser intensity profile results in slight shifts of the peak position of the spectra. Simulation VIII using the super-Gaussian laser and curved front surface demonstrates the highest mean ion energy of 31 MeV, compared to 27 MeV for simulations VI and VII.

TABLE 1
Simulation I details and parameters

| Variables | Normalized Values |
|---|---|
| Plasma density | nₚ/n_{crit} = 40 |
| a₀ = eE_{⊥}/mcω_{L} | 43 |
| Longitudinal profile | λ/c up/down ramp, 11λ/c flat |
| Focal length (R_{c}) | 40λ_{L} |
| Target radius (rₜ) | 8λ_{L} |
| Thickness of bulge (h) | 0.8λ_{L} |
| Thickness at center (d) | 5λ_{L} |
| Cell size (Δx × Δy × Δz) | $\frac{{λ}_{L}}{32} \times \frac{{λ}_{L}}{16} \times \frac{{λ}_{L}}{16}$ |
| Particles per cell | 27 |
| Time step (Δt) | $\frac{1}{48} \frac{ct}{{λ}_{L}}$ |

TABLE 2
Summary of simulation parameters

| Sim. | R_{c}(μm) | a₀ | $\frac{n}{{n}_{crit}}$ | $Θ ( \frac{{E}_{i}}{amu} ( MeV ) )$ | Pₜ(PW) | $ρ ( \frac{g}{{cm}^{3}} )$ |
|---|---|---|---|---|---|---|
| I | 40 | 43 | 40 | 0.025(35) | 10 | 0.074 |
| II | 60 | 43 | 40 | 0.025(35) | 22.5 | 0.074 |
| III | 20 | 43 | 40 | 0.025(35) | 2.5 | 0.074 |
| IV | 40 | 21.5 | 40 | 0.006(10) | 2.5 | 0.074 |
| V | 40 | 21.5 | 4 | 0.063(77) | 2.5 | 0.007 |
| VI | ∞ | 43 | 40 | 0.025(35) | 6.5 | 0.074 |
| VII | 40 | 43 | 40 | 0.025(35) | 6.5 | 0.074 |
| VIII | 40 | 43 | 40 | 0.025(35) | 8.1 | 0.074 |
| IX | 40 | 43 | 30 | 0.025(35) | 10 | 0.074 |

### REFERENCES

[1] D. Strickland and G. Mourou, Opt. Comm. 56, 219 (1985).
[2] C. Danson, D. Hillier, N. Hopps, and D. Neely, High Power Laser Sci. Eng. 3, e3 (2015).
[3] A. Macchi, M. Borghesi, and M. Passoni, Rev. Mod. Phys. 85, 751 (2013).
[4] S. M. Weng, Z. M. Sheng, M. Murakami, M. Chen, M. Liu, H. C. Wang, T. Yuan, and J. Zhang, Matter Radiat. Extremes 3, 28 (2018).
[5] T. Esirkepov, M. Borghesi, S. V. Bulanov, G. Mourou, and T. Tajima, Phys. Rev. Lett. 92, 175003 (2004).
[6] N. Naumova, T. Schlegel, V. T. Tikhonchuk, C. Labaune, I. V. Sokolov, and G. Mourou, Phys. Rev. Lett. 102, 025002 (2009).
[7] T. Schlegel, N. Naumova, V. T. Tikhonchuk, C. Labaune, I. V. Sokolov, and G. Mourou, Phys. Plasmas 16, 083103 (2009).
[8] A. P. L. Robinson, P. Gibbon, M. Zepf, S. Kar, R. G. Evans, and C. Bellei, Plasma Phys. Control. Fusion 51, 024004 (2009).
[9] A. Macchi, F, Cattani, T. V. Liseykina, and F. Cornolti, Phys. Rev. Lett. 94, 165003 (2005).
[10] S. C. Wilks, A. B. Langdon, T. E. Cowan, M. Roth, M. Singh, S. Hatchett, M. H. Key, D. Pennington, A. MacKinnon, and R. A. Snavely, Phys. Plasmas 8, 542 (2001).
[11] P. K. Patel, A. J. Mackinnon, M. H. Key, T. E. Cowan, M. E. Foord, M. Allen, D. F. Price, H. Ruhl, P. T. Springer, and R. Stephens, Phys. Rev. Lett. 91, 125004 (2003).
[12] X. F. Shen, A. Pukhov, and B. Qiao, Phys. Rev. X 11, 041002 (2021).
[13] L. Yin, B. J. Albright, K. J. Bowers, D. Jung, J. C. Fernindez, and B. M. Hegelich, Phys. Rev. Lett. 107, 045003 (2011).
[14] M. Tabak, J. Hammer, M. E. Glinsky, W. L. Kruer, S. C. Wilks, J. Woodworth, E. Michael Campbell, M. D. Perry, and R. J. Mason, Phys. Plasmas 1, 1626 (1994).
[15] J. C. Fernández, J. J. Honrubia, B. J. Albright, K. A. Flippo, D. Cort Gautier, B. M. Hegelich, M. J. Schmitt, M. Temporal, and L. Yin, Nucl. Fusion 49, 065004 (2009).
[16] J. J. Honrubia, J. C. Fernandez, M. Temporal, B. M. Hegelich, and J. Meyer-ter Vehn, Phys. Plasmas 16, 102701 (2009).
[17] J. J. Honrubia and M. Murakami, Phys. Plasmas 22, 012703 (2015).
[18] A. B. Zylstra et al., Nature 601, 542 (2022).
[19] A. L. Kritcher et al., Nat. Phys. 18, 251 (2022).
[20] H. Abu-Shawareb et al., Phys. Rev. Lett. 129, 075001 (2022).
[21] S. Atzeni, Phys. Plasmas 6, 3316 (1999).
[22] T. Bartal et al., Nature Phys. 8, 139 (2012).
[23] T. Toncian et al., Science 312, 410 (2006).
[24] T. Wang, V. Khudik, and G. Shvets, Phys. Rev. Lett. 126, 024801 (2021).
[25] R. S. Rajawat, T. Wang, V. N. Khudik, and G. Shvets, in preparation.
[26] Smilei: A collaborative, open-source, multi-purpose particle-in-cell code for plasma simulation, Comput. Phys. Commun. 222, 351 (2018).
[27] Y. Wan, I. A. Andriyash, W. Lu, W. B. Mori, and V. Malka, Phys. Rev. Lett. 125, 104801 (2020).
[28] Y. Wan et al., Phys. Rev. Lett. 117, 234801 (2016).
[29] Y. Wan, C.-H. Pai, C. J. Zhang, F. Li, Y. P. Wu, J. F. Hua, W. Lu, C. Joshi, W. B. Mori, and V. Malka, Phys. Rev. E 98, 013202 (2018).
[30] A. Sgattoni, S. Sinigardi, L. Fedeli, F. Pegoraro, and A. Macchi, Phys. Rev. E 91, 013106 (2015).
[31] B. Eliasson, New J. Phys. 17, 033026 (2015).
[32] V. Khudik, S. A. Yi, C. Siemon, and G. Shvets, Phys. Plasmas 21, 013110 (2014).
[33] C. Bellei, M. E. Foord, T. Bartal, M. H. Key, H. S. McLean, P. K. Patel, R. B. Stephens, and F. N. Beg, Phys. Plasmas 19, 033109 (2012).
[34] V. F. Kovalev and V. Yu. Bychenkov, Phys. Rev. Lett. 90, 185004 (2003).
[35] D. S. Dorozhkina and V. E. Semenov, Phys. Rev. Lett. 81, 2691 (1998).
[36] P. Mora, Phys. Rev. Lett. 90, 185002 (2003).
[37] P. Mora, Phys. Plasmas 12, 112102 (2005).
[38] A. Einstein, Annalen der Physic 17, 50 (1905).
[39] H.-G. Jason Chou, A. Grassi, S. H. Glenzer, and F. Fiuza, J. Plasma Phys. 88, 905880606 (2022).
[40] H.-G. Jason Chou, A. Grassi, S. H. Glenzer, and F. Fiuza, Phys. Rev. Res. 4, L022056 (2022).
[41] F. Brunel, Phys. Rev. Lett. 59, 52 (1987).
[42] S. M. Weng, M. Murakami, P. Mulser, and Z. M. Sheng, New J. Physics 14, 063026 (2012).
[43] S. M. Weng, P. Mulser, and Z. M. Sheng, Phys. Plasmas 19, 022705 (2012).
[44] S. Fourmaux, S. Payeur, S. MacLean, and J. C. Kieffer, in High-Brightness Sources and Light-Driven Interactions, OSA technical digest, paper JM7A.1 (2016).
[45] T. D. Malouff, A. Mahajan, S. Krishnan, C. Beltran, D. S. Seneviratne, and D. Michael Trifiletti, Front. Oncol. 10, 82 (2020).
[46] S. V. Bulanov and V. S. Khoroshkov, Plasma Phys. Rep. 28, 453 (2002).
[47] M. M. Günther, O. N. Rosmej, P. Tavana, M. Gyrdymov, A. Skobliakov, A. Kantsyrev, S. Zahter, N. G. Borisenko, A. Pukhov, and N. E. Andreev, Nat. Commun. 13, 170 (2022).
[48] M. Roth et al., Phys. Rev. Lett. 110, 044802 (2013).
[49] C.-K. Huang, B. J. Albright, L. Yin, H.-C. Wu, K. J. Bowers, B. M. Hegelich, and J. C. Fernández, Phys. Rev. ST Accel. Beams 14, 031301 (2011).
[50] S. G. Rykovanov, J. Schreiber, J. Meyer ter Vehn, C. Bellei, A., Henig, H C. Wu, and M. Geissler, New J. Phys. 10, 113005 (2008).

### Combinations of Features

Features described above as well as those claimed below may be combined in various ways without departing from the scope hereof. The following examples illustrate possible, non-limiting combinations of features and embodiments described above. It should be clear that other changes and modifications may be made to the present embodiments without departing from the spirit and scope of this invention:

(A1) A method includes illuminating a convex front face of a solid target with a laser pulse. Said illuminating generates an ion beam and accelerates the ion beam based at least in part on hole-boring radiation pressure acceleration such that the ion beam is focused onto a focal point located behind a rear face of the target.

(A2) In the method denoted (A1), the laser pulse is a femtosecond laser pulse.

(A3) In the method denoted (A2), the femtosecond laser pulse has a duration between 10 and 200 fs.

(A4) In any of the methods denoted (A1) to (A3), the method further includes generating the laser pulse by amplifying a seed pulse with chirped pulse amplification.

(A5) In the method denoted (A4), the method further comprises generating the seed pulse.

(A6) In any of the methods denoted (A1) to (A5), the laser pulse is circularly or elliptically polarized.

(A7) In any of the methods denoted (A1) to (A6), the laser pulse approximates a plane wave.

(A8) In any of the methods denoted (A1) to (A7), the laser pulse has a Gaussian or super-Gaussian profile.

(A9) In any of the methods denoted (A1) to (A8), the laser pulse has a peak intensity of at least 10²⁰ W/cm³.

(A10) In any of the methods denoted (A1) to (A9), the laser pulse has a spot size of at least 4 μm.

(A11) In any of the methods denoted (A1) to (A10), the method further includes using the ion beam to trigger nuclear fusion.

(A12) In the method denoted (A11), said using the ion beam includes igniting a deuterium-tritium pellet, a deuterium-deuterium pellet, or a boron target.

(A13) In the method denoted (A11) or (A12), the ion beam includes a beam of carbon ions, a beam of oxygen ions, a beam of protons, or a combination thereof.

(A14) In any of the methods denoted (A1) to (A11), the method further includes using the ion beam to deposit energy in biological tissue.

(A15) In the method denoted (A14), the ion beam includes a beam of protons.

(A16) In any of the methods denoted (A1) to (A15), said illuminating includes illuminating, with a first laser pulse, a first convex front face of a first solid target to generate a first ion beam, accelerate the first ion beam based on least on hole-boring radiation pressure acceleration, and focus the first ion beam onto a first focal point located behind a first rear face of the first target. The method also includes illuminating, with a second pulse, a second convex front face of a second target to generate a second ion beam, accelerate the second ion beam based at least in part on hole-boring radiation pressure acceleration, and focus the second ion beam onto a second focal point located behind a second rear face of the second target.

(A17) In the method denoted (A17), said illuminating the first convex front face and said illuminating the second convex front face occur simultaneously.

(A18) In the method denoted (A17), the first and second focal points at least partially overlap.

(B1) A target includes a piece of solid material having a convex front face and a rear face. A thickness of the piece of solid material, as measured between the rear face and a transverse center of the convex front face, is at least 1 μm.

(B2) In the target denoted (B1), the rear face is planar.

(B3) In the target denoted (B1) or (B2), the piece of solid material has a mass density of 0.2 g/cm³ or less.

(B4) In any of the targets denoted (B1) to (B3), the solid material includes an aerogel, an aerographite, a carbon nanofoam, or a combination thereof.

(B5) In any of the targets denoted (B1) to (B4), the convex front face is parabolic to at least first order with respect to transverse distance from the transverse center.

(B6) In any of the targets denoted (B1) to (B5), the convex front face is spherical.

(B7) In any of the targets denoted (B1) to (B6), the convex front face is stepped.

(B8) In any of the targets denoted (B1) to (B7), the piece of solid material is filled between the convex front face and the rear face.

(B9) In any of the targets denoted (B1) to (B13), the convex front face has a radius of at least 1 pum.

(B10) In any of the targets denoted (B1) to (B9), the piece of solid material includes a front portion forming the convex front face and a first intermediate face that is planar. The piece of solid material also includes a rear portion forming the rear face and a second intermediate face that is planar and parallel to the second intermediate face. The first and second intermediate faces meet.

(B11) In the target denoted (B10), the front portion has a protrusion distance of at least 1 μm.

(B12) In the target denoted (B10) or (B111), the front portion has a protrusion distance that is similar to a thickness of the rear portion.

(B13) In the target denoted (B10) or (B11), the front portion has a protrusion distance that is less than a thickness of the rear portion.

(B14) In any of the targets denoted (B10) to (B13), the front portion includes a first material and the rear portion includes a second material different from the first material.

(B15) In the target denoted (B14), the first and second materials have different mass densities.

(C1) A system includes any of the targets denoted (B1) to (B15). The system also includes one or more beam-focusing optics configured to focus an ion beam emitted from the target.

(C2) In the system denoted (C1), the one or more beam-focusing optics include one or both of a quadrupole magnet and a solenoid.

(C3) In the system denoted (C1) or (C2), at least one of the one or more beam-focusing optics has an adjustable focal length.

(C4) In any of the systems denoted (C1) to (C3), the system further includes one or more of an energy selection aperture, a time-of-flight spectrometer, an ionization chamber, a beam profiler, a dipole chicane, and a sample bedding unit.

(C5) In any of the systems denoted (C1) to (C4), at least one dimension of the convex front face is greater than or equal to at least one dimension of a laser beam configured to illuminate the convex front face of the target.

(C6) In any of the systems denoted (C1) to (C5), the system is configured for use as a converging-front laser ion accelerator, a converging surface ion accelerator, a proton therapy device, a neutron beam generator, a warm dense matter generator, or an ion radiography device.

(D1) A system includes any of the targets denoted (B1) to (B15). The system also includes a proton beam source. The target includes one or more converter materials such that the proton beam source is configured to irradiate the one or more converter materials to generate neutrons by nuclear reactions between protons of the proton beam source and the one or more converter materials.

(D2) In the system denoted (D1), the one or more converter materials includes lithium, beryllium, gold, chromium, or any combination thereof.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. A method, comprising:
illuminating a convex front face of a solid target with a laser pulse;
wherein said illuminating generates an ion beam and accelerates the ion beam based at least in part on hole-boring radiation pressure acceleration such that the ion beam is focused onto a focal point located behind a rear face of the solid target.

2. The method of claim 1, the laser pulse being a femtosecond laser pulse.

3. (canceled)

4. The method of claim 1, further comprising generating the laser pulse by amplifying a seed pulse with chirped pulse amplification.

5. (canceled)

6. The method of claim 1, the laser pulse being circularly or elliptically polarized.

7. The method of claim 1, the laser pulse approximating a plane wave.

8. The method of claim 1, the laser pulse having a Gaussian or super-Gaussian profile.

9. The method of claim 1, the laser pulse having a peak intensity of at least 10²⁰ W/cm².

10. The method of claim 1, the laser pulse having a spot size at the convex front face of at least 4 μm.

11. The method of claim 10, further comprising using the ion beam to trigger nuclear fusion.

12. The method of claim 11, wherein said using the ion beam comprises igniting a deuterium-tritium pellet, a deuterium-deuterium pellet, or a boron target.

13. The method of claim 11, the ion beam comprising a beam of carbon ions, a beam of oxygen ions, a beam of protons, or a combination thereof.

14. The method of claim 1, further comprising using the ion beam to deposit energy in biological tissue.

15. The method of claim 14, the ion beam comprising a beam of protons.

16. The method of claim 1, wherein:
said illuminating comprises illuminating, with a first laser pulse, a first convex front face of a first solid target to generate a first ion beam, accelerate the first ion beam based at least in part on hole-boring radiation pressure acceleration, and focus the first ion beam onto a first focal point located behind a first rear face of the first target; and
the method comprises illuminating, with a second laser pulse, a second convex front face of a second target to generate a second ion beam, accelerate the second ion beam based at least in part on hole-boring radiation pressure acceleration, and focus the second ion beam onto a second focal point located behind a second rear face of the second target.

17. The method of claim 16, wherein said illuminating the first convex front face and said illuminating the second convex front face occur simultaneously.

18. The method of claim 16, the first and second focal points at least partially overlapping.

19. The method of claim 1, wherein a thickness of the solid target, as measured between the rear face and a transverse center of the convex front face, is at least 1 μm.

20. The method of claim 1, wherein one or more of:
the rear face is planar;
the solid target is composed of a material having a mass density of 0.2 g/cm³ or less;
the solid target is composed of an aerogel, an aerographite, a carbon nanofoam, or a combination thereof;
the convex front face is parabolic to at least first order with respect to a transverse distance from the transverse center;
the convex front face is spherical;
the convex front face is stepped;
the solid target is filled between the convex front face and the rear face; and
the convex front face has a radius of at least 1 μm.

21-27. (canceled)

28. The method of claim 1, the solid target comprising:
a front portion forming the convex front face and a first intermediate face that is planar; and
a rear portion forming the rear face and a second intermediate face that is planar and parallel to the second intermediate face;
wherein the first and second intermediate faces meet.

29-39. (canceled)

40. The method of claim 1, wherein:
wherein the solid target comprises one or more converter materials; and
the method further comprises irradiating the one or more converter materials with a proton beam to generate neutrons by nuclear reactions between protons of the proton beam and the one or more converter materials.

41. (canceled)
